(19) United States
(12) Patent Application Publication
(10) Pub. No.: US 2004/0037016 A1
(43) Pub. Date: Feb. 26, 2004

(54) Complex functional device and method of manufacturing the same, and haptic information system and information input apparatus comprising that complex functional device

(76) Inventors: Norio Kaneko, Kanagawa (JP); Makoto Ogusu, Tochigi (JP)

Correspondence Address: ROBIN BLECKER & DALEY, 2ND FLOOR, 330 MADISON AVENUE, NEW YORK, NY, 10017, US

(21) Appl. No.: 10/647,412

(22) Filed: Aug. 25, 2003

(30) Foreign Application Priority Data
Aug. 26, 2002 (JP) 2002-245299(PAT.)
Sep. 6, 2002 (JP) 2002-261533(PAT.)
Oct. 29, 2002 (JP) 2002-314743(PAT.)

(51) Int. Cl. H02H 3/00

(52) U.S. Cl. 361/1

(57) ABSTRACT

An information process of various kinds of haptic information such as a temperature, pressure, and the like, which is approximate to human haptic sense, is easily achieved in a wide variety of applications in different fields such as detection of various three-dimensional patterns, the surface states of paper and the like, an input device to an information apparatus, and the like without damaging a device. To this end, a single haptic information element simultaneously handles a plurality of kinds of information, i.e., a temperature and pressure, using a ferroelectric or pyroelectric which responds to both the temperature and pressure. Furthermore, not only these pieces of information are detected, but also some or all pieces of detected information are expressed under the control using an external power supply by forming the ferroelectric or pyroelectric on a hollow space structure, i.e., a cantilever or simple beam. A metal oxide film is divided into a plurality portions, and a plurality of different kinds of information are detected by electrodes formed on the respective portions. Hence, even when one detection element is damaged, the functions of other detection elements can be assured, and the manufacturing process is simplified. Moreover, an information input/output apparatus with these devices is provided.

### CLAIM OF PRIORITY

The present application claims priority under 35 U.S.C. § 119 from three Japanese Patent Applications: 1) No. 2002-245299, entitled “A Complex Functional Device and A Haptic Information System” and filed on Aug. 26, 2002, 2) No. 2002-261533, entitled “A complex functional apparatus and A Method Thereof” and filed on Sep. 6, 2002 and 3) No. 2002-314743, entitled “An Information Input Apparatus” and filed on Oct. 29, 2002, the entire contents of which are hereby incorporated by reference herein.

### FIELD OF THE INVENTION

The present invention relates to a complex functional device which simultaneously or separately detects a temperature and pressure, and a method of manufacturing the same and, more particularly, to a complex functional device which can solely detect an unevenness, friction, pressure, or temperature, or haptic(the term “haptic” may be replaceable by “tactile” hereinafter.) information as a combination of them in recording media detection for various printers, copying machines, LBPs, and the like, or touch panels of information apparatuses such as personal computers, PDAs, portable phones, and the like, and also in food robots, medical robots, various industrial robots, or various security systems and the like. Furthermore, the present invention relates to an information input/output apparatus comprising such complex functional device.

### BACKGROUND OF THE INVENTION

Most of devices associated with so-called haptic sense convert pressure information into an electrical signal. Representative devices detect a capacitance and a change in electrical resistance using pressure-sensitive conductive elastomer or the like. For example, Japanese Patent Laid-Open No. 5-81977 proposes a haptic sensor which has an electrode provided to one end of pressure-sensitive conductive elastomer, and a terminal which has a contact projection and is provided to the other end, and exploits a change in electrical resistance of the pressure-sensitive elastomer when a pressure acts on the terminal.

Also, Japanese Patent Laid-Open No. 5-215625 proposes a haptic sensor which has elastomer arranged between electrodes, and detects a change in capacitance due to deformation of the elastomer by a pressure using the principle of a capacitor. Japanese Patent Laid-Open No. 9-203671 proposes a haptic sensor which detects a temperature and pressures in triaxial directions using a piezoelectric member.

Furthermore, Japanese Patent Laid-Open No. 5-216568 describes a haptic input/output apparatus which can handle a temperature and pressure at the same time. In this apparatus, a pressure sensor, pressure actuator, and temperature sensor are formed into needle shapes, and elements each including a set of these pressure sensor, pressure actuator, and temperature sensor are arranged at a high density to be used as an interface with a computer.

However, the haptic sensors in Japanese Patent Laid-Open Nos. 5-81977 and 5-215625 can detect a pressure in a linear direction, but cannot detect pressures in three-dimensional directions. Also, Japanese Patent Laid-Open No. 9-203671 can detect the temperature and pressures in the three-dimensional directions but cannot express a detected signal or pressure information selected in advance. According to the invention of Japanese Patent Laid-Open No. 9-203671, since different materials are used to detect the temperature and pressure, such different materials used to detect the temperature and pressure must be formed on a single substrate in the manufacture of a device, resulting in complicated manufacturing processes.

Furthermore, Japanese Patent Laid-Open No. 5-216568 can handle the pressure and temperature information at the same time, but suffers problems of durability and reliability since needle-shaped members are used. That is, each of the three different needle-shaped sensors and actuator is as small as 300 μm or less to achieve human haptic resolution, e.g., a fingertip, and one needle-shaped member is very thin. For this reason, the mechanical strength of each member is low. Hence, external information can be detected, but these members may be readily destroyed due to their low mechanical strength even if materials are devised. Especially, in order to transmit a signal associated with the presence/absence and magnitude of displacement to a person (to convey the presence/absence and magnitude of displacement to a finger while the distal end portion of a needle-shaped material is pressed against the finger or the like), a large voltage must be applied, and the device may mechanically destroy itself by its own force. Furthermore, if one of these devices is destroyed, a function of the haptic device is lost.

### SUMMARY OF THE INVENTION

The present invention has been made in consideration of the aforementioned probl ms, and provides a complex functional device, which can achieve an information process of various kinds of haptic information such as a temperature, pressure, and the like, which is approximate to human haptic sense, in a wide variety of applications in different fields such as detection of various three-dimensional patterns, the surface states of paper and the like, an input device to an information apparatus, and the like, and a haptic information system.

In addition, the present invention assures functions of other detection elements even when one detection element is destroyed, and to simplify manufacturing processes.

A complex functional device according to the present invention comprises a haptic information element having haptic information portions corresponding to a plurality of different kinds of haptic information, and each haptic information portion includes a first function of detecting corresponding haptic information, and a second function of reproducing some or all pieces of detected haptic information.

In one aspect of the complex functional device according to the present invention, each haptic information portion has a plurality of electrode pairs, the first function obtains detection signals of the haptic information via the electrode pairs, and the second function reproduces some or all pieces of haptic information by converting the haptic information into physical quantities which are the same as or different from the detection signals by inputting electric power from an external power supply to the electrode pairs.

Furthermore, a complex functional device according to the present invention is characterized by detecting a plurality of different kinds of information by electrodes formed on a plurality of portions obtained by dividing a metal oxide film.

A method of manufacturing a complex functional device according to the present invention is directed to a method of manufacturing a complex functional device which detects a plurality of different kinds of information by electrodes formed on a plurality of portions obtained by dividing a metal oxide film, comprising: forming the metal oxide layer by independently supplying a metal source material and oxygen source material which form the metal oxide layer to a substrate.

Furthermore, an information input/output apparatus according to the present invention is directed to an information input/output apparatus for controlling an operation of a target apparatus on the basis of a user authentication result associated with a user who operates the target apparatus, comprising menu presentation means for presenting a list of a plurality of menu items used to operate the target apparatus, fingerprint information acquisition means for acquiring fingerprint information of the user on the basis of a position of the menu item that the user touches with a finger of the plurality of menu items presented by the menu presentation means, and user authentication means for authenticating the user on the basis of the fingerprint information acquired by the fingerprint information acquisition means.

Other features and advantages of the present invention will be apparent from the following descriptions taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the descriptions, serve to explain the principle of the invention.

FIG. 1 is a schematic sectional view showing a haptic information element in a complex functional device according to the first embodiment of the present invention;

FIG. 2 is a schematic sectional vi w showing the second example of a haptic information element in a complex functional device according to the second embodiment of the present invention;

FIG. 3 is a schematic plan view of a haptic information element in a complex functional device according to the present invention;

FIG. 4 is a schematic plan view of a line sensor formed by linearly arranging haptic information elements;

FIG. 5 is a schematic plan view of a two-dimensional sensor formed by two-dimensionally arranging haptic information elements;

FIG. 6 shows a measurement sample of the complex functional device of the present invention;

FIG. 7 is a sectional view taken along a line A A′ in FIG. 6;

FIG. 8 is a graph showing a pressure detection example using the complex functional device of the present invention;

FIG. 9 is a block diagram showing an example of the arrangement of a haptic information system including the complex functional device of the present invention;

FIGS. 10A to 10H are schematic sectional views showing the fabrication sequence of the complex functional device of the present invention;

FIGS. 11A to 11I are schematic sectional views showing the fabrication sequence of the complex functional device of the present invention;

FIG. 12 is a view showing the structure of a complex functional device according to the third embodiment of the present invention;

FIG. 13 is a view showing a complex functional sensor formed by two-dimensionally arranging detection element groups;

FIGS. 14A and 14B are views showing the structure of a complex functional device according to the fourth embodiment of the present invention;

FIG. 15 is a view showing the structure of a complex functional device according to the fifth embodiment of the present invention;

FIG. 16 is a plan view showing a wafer pattern used to verify the characteristics of a complex functional device according to an embodiment of the present invention;

FIG. 17 is a sectional view showing a wafer pattern used to verify the characteristics of a complex functional device according to an embodiment of the present invention;

FIG. 18 is a graph showing the characteristics of a pressure detection unit (pressure detection element) of a complex functional device according to an embodiment of the present invention;

FIGS. 19A to 19G are views showing the flow of a method of manufacturing a complex functional device according to an embodiment of the present invention;

FIG. 20 is a chart showing the flow of a detection process of temperature and pressure information;

FIG. 21 is a view showing the principle of activation of a source gas used upon generating a metal oxide film according to an embodiment of the present invention;

FIG. 22 is a view illustrating the arrangement of the first embodiment of an information input/output apparatus according to the present invention;

FIG. 23 is a functional block diagram for explaining the functions of the information input/output apparatus;

FIG. 24 shows an example of the layout of haptic display elements which form an apparatus display & input unit;

FIG. 25 is a view illustrating the arrangement of the second embodiment of an information input/output apparatus according to the present invention;

FIG. 26 is a functional block diagram for explaining the functions of the third embodiment of an information input/output apparatus according to the present invention; and

FIG. 27 is a block diagram showing an example of the arrangement of a computer system which can make a computer implement the functions of the information input/output apparatus.

### DETAILED DESCRIPTION OF THE PREFERRED EMBODIMENTS

A complex functional device will be explained first, and an information input/output apparatus which incorporates that device will then be explained.

<Complex Functional Device>

A. Embodiment

(1) First Embodiment

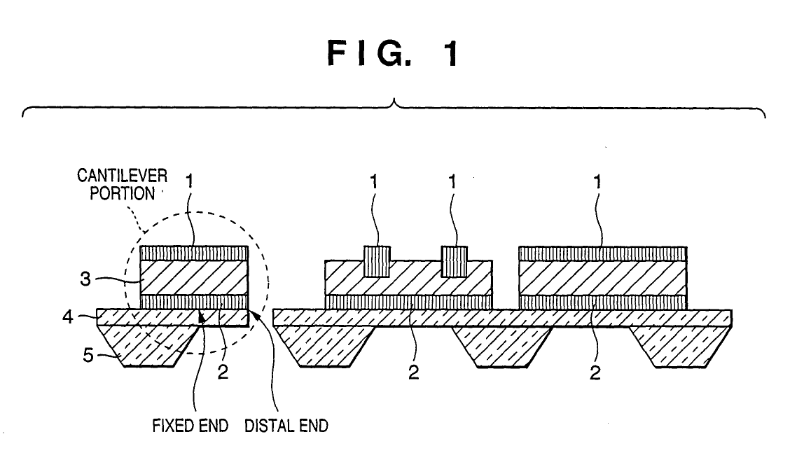

This embodiment will be explained below using FIG. 1.

In a haptic information element shown in FIG. 1, reference numeral 5 denotes a substrate which is formed of a material such as silicon, glass, metal, plastic, or the like. Reference numeral 4 denotes an elastic member which is formed of a material such as silicon, glass, metal, plastic, or the like. Components 4 and 5 or 2 and 4 may use the same material. Reference numeral 3 denotes a metal oxide, the composition of which is not particularly limited as long as it is a ferroelectric or pyroelectric. Reference numerals 1 and 2 denote electrodes. The electrode 1 will be referred to as an upper electrode and the electrode 2 will be referred to as a lower electrode for the sake of convenience. In FIG. 1, the left haptic information portion d tects a vertical pressure, the c ntral haptic information portion detects a horizontal pressure, and the right haptic information portion detects a temperature. Furthermore, these portions have a function of reproducing these pieces of haptic information.

A case will be exemplified below wherein the metal oxide material adopts a ferroelectric such as lead zirconate titanate (to be referred to as PZT hereinafter). If a c-axis orientation film of PZT is grown using a normal thin film technique, the left end portion sandwiched between the electrodes 1 and 2 can detect a pressure vertically acting on PZT using the electrodes 1 and 2 by exploiting piezoelectric property d₃₃ of the PZT. Also, the central portion can detect a pressure horizontally acting on the PZT film by the electrode pair embedded in the PZT film using piezoelectric properties d₃₁, d₁₅, d₂₄, and the like of the PZT. The right end portion can detect a temperature based on a voltage generated across the electrodes 1 and 2 by exploiting the pyroelectricity of the PZT.

In FIG. 1, the metal oxide 3 and lower electrode 2 are separated into three, but they may be separated only partially. When the elastic member 4 adopts a material such as a metal or the like having electric conductivity, an insulating member may be inserted between the electrode 2 and elastic member 4. The thicknesses and areas of the elastic member, substrate, metal oxide, and electrodes may be appropriately selected depending on the intended purposes. For example, when an arbitrary object contacts a complex functional device of the present invention at a pressure ranging from 0.4 to 1.0 kg/cm², and a temperature within the range of ±30° from room temperature is to be measured, the total thickness of a stacked structure of the electrodes and metal oxide can generally fall within the range from 0.001 to 3.0 mm.

The length from the fixed end to the distal end of a cantilever portion in the left portion of FIG. 1 is not limited upon detecting a pressure. However, when pressure information is reproduced, a displacement amount of about 10 μm or more in the up-and-down direction is preferably assured to allow a person to easily sense such information. In order to obtain this displacement, if PZT is used as the metal oxide, the length from the fixed end to the distal end is preferably about 100 μm or more.

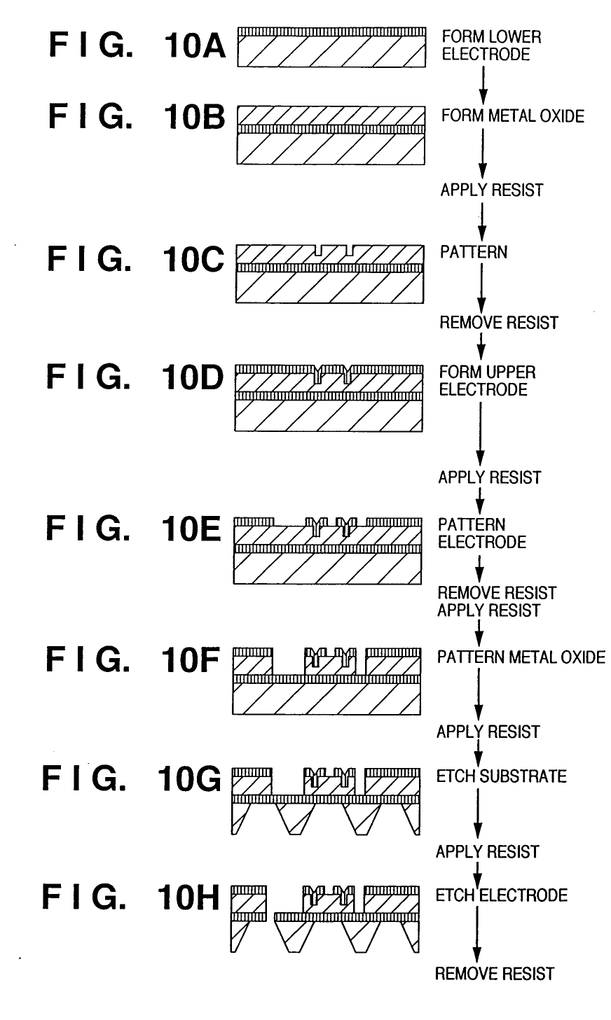

FIGS. 10A to 10H show a method of fabricating the complex functional device according to this embodiment. In this case, a silicon wafer having a 2-μm thick thermal oxide film (silicon oxide) was used as the substrate 1. This thermal oxide film (not shown in FIGS. 10A to 10H) is used as the elastic member. Pt/Ti (Pt: 500 nm thick, Ti: 8 nm thick) was formed as a lower electrode by PF sputtering, and (Pb, La)(Zr, Ti)O₃ (to be abbreviated as PLZT hereinafter) was formed as a metal oxide by RF sputtering (FIGS. 10A and 10B).

In this embodiment, the composition was controlled to have Pb/La=95/5 atomic % and Zr/Ti=30/70 atomic %, and the film thickness was 4 μm. The PLZT film is patterned by an aqueous solution mixture of hydrofluoric acid and nitric acid using a resist (e.g., AZ4620 or the like), as shown in FIG. 10C. The etching depth of the PLZT film was 500 nm. After the resist was removed by oxygen plasma, an upper electrode was formed (FIG. 10D). The upper electrode uses the same material as the lower electrode and also has the same film thickness.

The electrodes and metal oxide were patterned in turn (FIGS. 10E and 10F). As patterning conditions, the electrodes were patterned by dry etching using Ar plasma, and the PLZT film was patterned by wet etching using an aqueous solution mixture of hydrofluoric acid and nitric acid. After a resist used at that time was removed, the silicon substrate was etched (FIG. 10H). As a mask at this time, a silicon nitride film was formed by LPCVD, and was etched using CF₄ plasma after it was patterned using a resist (AZ1500). After that, the silicon substrate was removed by a potassium hydroxide aqueous solution, and the resist was removed. After applying a resist again, the electrode of a prospective cantilever portion was removed by dry etching.

In the aforementioned fabrication method, the upper and lower electrodes have the same material and the same thickness. However, the present invention is not limited to this. No problem is posed if the upper and lower electrodes are formed of different materials. As an electrode, for example, a conductive oxide, conductive polymer, and the like may be used in addition to a metal. In the cantilever portion, the total film thickness or Young's modulus of the stacked structure of the lower electrode and elastic member must be different from those of the upper electrode, or the area of the lower electrode or elastic member must be different from that of the upper electrode. The elastic member and lower electrode may be formed of either the same material or different materials.

The metal oxide is not particularly limited as long as it is a ferroelectric, pyroelectric, or the like. For example, PZT, PLZT, barium titanate, lithium niobate, lithium tantalate, bismuth titanate, materials obtained by adding various metal elements to them, and their mixed crystals (e.g., Pb(Mg_{1/3}Nb_{2/3})O₃-PbTiO₃, 0.7Pb(Ni_{1/3}Nb_{2/3})O₃-PbTiO₃, 0.7Pb(Co_{1/3}Nb_{2/3})O₃-Pb(Zr, Ti)O₃, and the like) may be used.

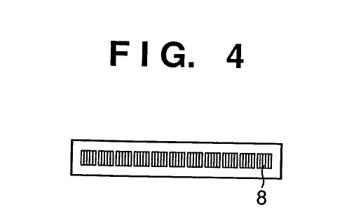

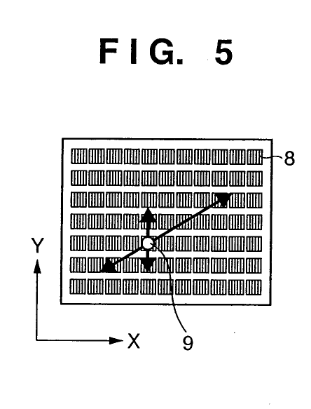

By linearly or two-dimensionally arranging such haptic information elements 8, as shown in FIG. 4 or 5, a linear or two-dimensional complex functional device which simultaneously detects the temperature and pressures, i.e., detects information corresponding to haptic sense (haptic information) upon comparison to the human five senses can be formed.

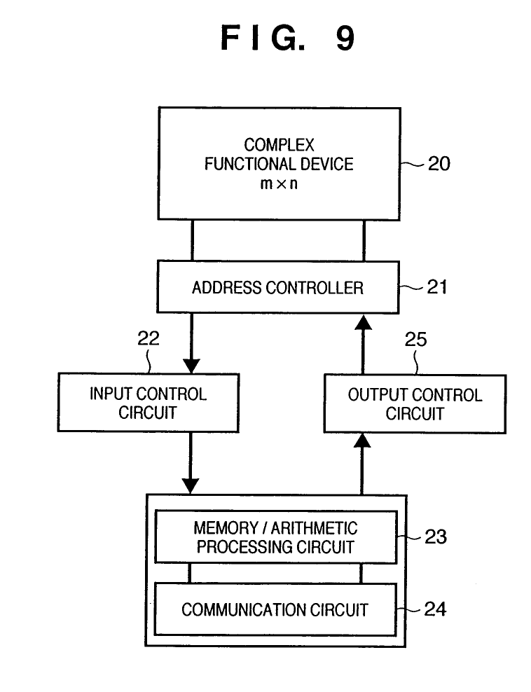

More specifically, as shown in FIG. 9 that shows the arrangement of a haptic information system, when an arbitrary object touches a complex functional device 20 which is formed by arranging m×n (m≧0, n≧0, and m and n do not simultaneously assume zero) haptic information elements 8, the output signals from the respective haptic information elements 8 are sent to an input control circuit 22 via an address controller 21, and undergo required signal processes such as amplification, a noise process, and the like. After that, the processed signals undergo a desired information process in a memory/arithmetic processing circuit 23. The outputs from the respective elements, which have undergone the information process are saved in a memory, and can be transmitted to a computer or the like via, e.g., the Internet using a communication circuit 24 as needed. On the other hand, in order to retrieve information already saved in the memory or information which is received via the Internet or the like by the communication circuit 24 and is saved in the memory, signals are supplied to the complex functional device 20 using an output control circuit 25 via the address controller 21. If haptic information is converted into digital information, and is then saved in the memory, it can be handled in the same manner as video information, text information, and the like. That is, it is useful since haptic information can be handled in “five-sense communication” that attracts the attention recently.

As a result, since the pressure detection portions mechanically displace as piezoelectric elements, a person can feel saved information by touching the device surface. In this case, the temperature detection portions can serve as a display unit of pressure information by applying a voltage to the upper and lower electrodes.

When an arbitrary object contacts a certain portion 9 of, e.g., a two-dimensional matrix of a large number of haptic information elements 8, and that object moves in various directions, as indicated by the arrows, the moving direction, temperature, and pressure information can be detected by sequentially reading the outputs from the respective haptic information elements 8 by the input control circuit via the address controller 21. The layout spacing of the haptic information elements 8 may be determined depending on the int nded purposes. For example, upon detecting a fingerprint or the like of a person, the layout spacing may be about 50 μm. When the device is used as a touch panel of an information terminal such as a PDA or the like, pressure information need only be fetched, and the element spacing can fall within the range from 0.1 to 10 mm. The number of haptic information elements 8 need only be set depending on the intended purposes, and is not limited.

Upon displaying a pressure, the output control circuit applies a voltage across the electrodes 1 and 2 of each left end portion of desired haptic information elements via the address controller, so as to express pressure information as deformation of each electrode/metal oxide/electrode stacked structure in the up-and-down direction or as a vibration or sound by changing the voltage application method. In case of a horizontal pressure as well, pressure information can be expressed as a displacement in the up-and-down direction, vibration, or sound using the pairs of electrodes 1 and 2. Upon expressing the pressure information, a mechanism that emphasizes such mechanical displacement may be combined with the complex functional device.

As for temperature detection, a temperature is measured as an absolute value or a relative temperature change is measured. FIG. 1 shows the principle of the element sectional structure upon measuring a relative temperature in principle. That is, temperature detection using a pyroelectric is to detect a relative temperature. When an absolute temperature is to be measured, a temperature sensor as a standard such as a thermistor, thermocouple, or the like may be arranged around the detection portion, or a standard value may be input in advance to the arithmetic processing circuit upon measurement. A temperature is reproduced using the portion that detects a horizontal pressure. In pressure detection, the pairs of upper electrodes 1 are used. However, upon reproducing the temperature, heat is produced by applying pulse voltages to the lower and upper electrodes. A voltage to be applied is not limited as long as that voltage does not cause dielectric breakdown of the metal oxide.

(2) Second Embodiment

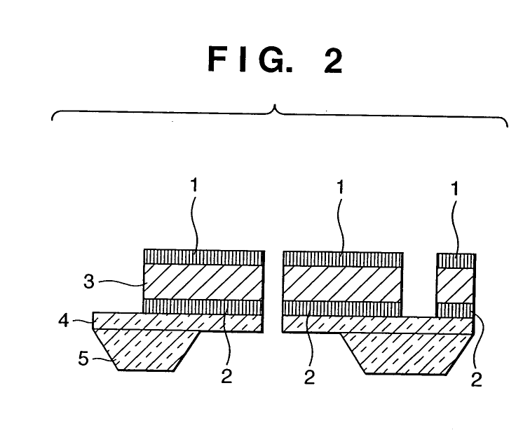

FIG. 2 shows the principle of the sectional structure of a complex functional element of the present invention. In this embodiment, the metal oxide 3 is attached to the elastic member 4 via the electrode 2. This elastic member may be formed of a material which is either the same as or different from the electrode. Irrespective of the material of the elastic member, the cantilever need only deform in the up-and-down direction by an external power supply so that the thickness and area of the stacked structure of the lower electrode and elastic member are different from those of the upper electrode, or they have different Young's modulus values.

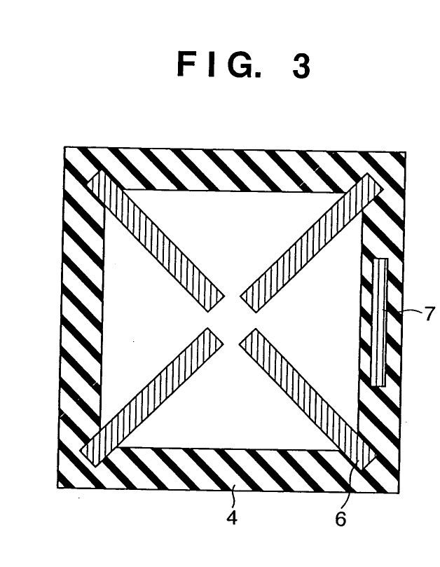

FIG. 3 is a plan view of the structure of the haptic information element shown in FIG. 2.

In FIG. 3, one element is made up of four cantilevers 6, which are attached to electrode/metal oxide/electrode stacked structures so as to cross at 900. However, the number of cantilevers is not limited to four as long as it is large enough to process electrical signals from electrode/metal oxide/electrode/elastic member stacked structures attached to respective cantilevers and to convert them into spatial information of a required number of dimensions. For example, three cantilevers may be arranged at threefold symmetry positions, i.e., they may oppose at 120°-angular positions, or two cantilevers may be arranged at twofold symmetry positions. In FIG. 3, the central portions of the cantilevers are arranged at a hollow space portion. Conversely, the cantilevers may be radially arranged from the central portion.

In FIG. 3, reference numeral 7 denotes a stacked structure, which is made up of an electrode/metal oxide/electrode, and is used to detect a temperature. In FIG. 3, this stacked structure is formed at one position. However, the number of stacked structures is not limited to one. An infrar d ray compatible optical system (not shown) may be arranged on a portion for detecting the temperature to efficiently focus external infrared rays. Furthermore, upon detecting a relative change in temperature, the outputs from the electrode/metal oxide/electrode stacked structures formed on a plurality of cantilevers may be compared, and the structure 7 may be omitted. In FIG. 2, the cantilever is illustrated to be parallel to the substrate. However, the cantilever may be curved upward with respect to the substrate by exploiting the surface stress of the substrate, elastic member, electrode, and metal oxide.

The thickness of each layer of the electrode/metal oxide/electrode/elastic member stacked structure is not particularly limited. However, in general, it is desirable to meet electrode/stacked structure=0.5 or less. Upon detecting a small pressure or making displacement with a large amplitude, the cantilever that extends over the hollow space structure portion preferably has a largest possible length, but such length may be determined depending on the intended purposes, i.e., the required mechanical strength, signal detection sensitivity, required displacement amount, and the like. If PZT is used as a metal oxide material and a mechanical displacement amount of 10 μm or more is to be assured, the PZT thickness may be about 3 μm to 3 mm, and the cantilever may have a length ranging from 100 μm to 1 mm. Furthermore, a rod-like object may be attached to the distal end portion of the cantilever to improve the sensitivity to the mechanical displacement. Furthermore, a mechanical displacement amplification function that applies the principle of leverage may be added.

A haptic information portion that detects the temperature is formed on the elastic member 4 in FIG. 2. However, in order to make high-speed measurement or repetitive measurement, the substrate may have a hollow space structure to reduce the heat capacity of the detection portion.

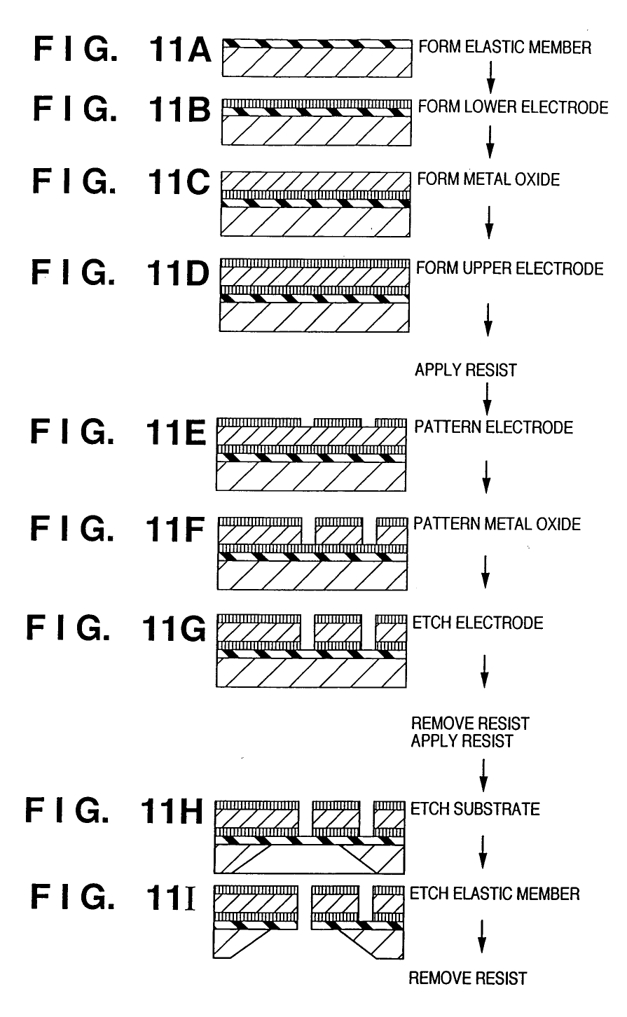

A method of fabricating the complex functional device of this embodiment will be described below. FIGS. 11A to 11I show the fabrication flow.

An elastic member is formed on a substrate Si. A 2-μm thick elastic member was formed by RF sputtering using silicon oxide (FIG. 11A). Pt/Ti films (6-nm thick Ti film/300-nm thick Pt film) were formed as a lower electrode by RF sputtering (FIG. 11B).

After that, a metal oxide material is formed. Formation means is not particularly limited as long as it is normal thin film formation means (such as vacuum deposition, various sputtering methods, MO-CVD, sol-gel process, ion-beam deposition, gas-jet process, and the like). In this embodiment, 0.7Pb(Mg_{1/3}Nb_{2/3})O₃-0.3PbTiO₃ was formed by the sol-gel process. In this case, a single coat had a film thickness of about 100 nm. Hence, coating and drying were repeated to finally obtain a film thickness of 4 μm. After that, the resultant structure underwent a heat treatment at 650° C. for five hours in an oxygen atmosphere, thus obtaining a metal oxide material (FIG. 11C). As an upper electrode, Pt/Ti films (5-nm thick Ti film/200-nm thick Pt film) were formed by RF sputtering. Then, the obtained structure was patterned using a novolak-based positive resist, and the Pt and Ti films were dry-etched using argon plasma and SF₆ plasma, respectively (FIG. 11E).

After that, the metal oxide 0.7Pb(Mg_{1/3}Nb_{2/3})O₃-0.3PbTiO₃ was etched by an aqueous solution mixture of hydrofluoric acid and nitric acid (FIG. 11F). A silicon nitride film was formed as a mask by low-pressure CVD, and that mask was patterned by CF₄ plasma using a resist (e.g., AZ1500). Then, the substrate Si (100) was anisotropically etched by a potassium hydroxide aqueous solution (FIG. 11H). Finally, the silicon oxide film of the elastic member was etched using an aqueous solution mixture of hydrofluoric acid and nitric acid to form a hollow space structure (FIG. 11I).

Using a linear array or a two-dimensional matrix of such haptic information elements (FIG. 2) fabricated in this way, pressure and t mperature information associated with haptic sense can be linearly or two-dimensionally detected/reproduced. The detected temperature/pressure signals are saved in the memory after being input from the address controller 21 and undergoing signal amplification and a noise-cut process in the input control circuit 22 and required signal processes in the memory/arithmetic processing circuit 23, as shown in FIG. 9. Signals are reproduced by driving the complex functional device 20 by the output control circuit 25 via the address controller 21 on the basis of the signals saved in the memory. The cantilevers 6 shown in FIG. 3 can independently displace in the up-and-down direction in accordance with a voltage from the output control circuit 25, thus reproducing pressure information in the vertical/horizontal direction. The reproduced information need not always be sensed by touching. For example, the frequency of the output from the output control circuit may be controlled to reproduce information as a sound.

The complex functional device of this embodiment need not always be arranged on a flat surface but may be arranged on a curved surface. Furthermore, if the materials used in this complex functional device adopt those which have high transparency with respect to visible light, the device can be stacked on a video display such as a liquid crystal display so as to display an image and haptic information together. For example, if the substrate and elastic member are formed of photosensitive glass, and both the upper and lower electrodes are made up of a transparent material such as ITO or the like, and if the metal oxide is a normal ferroelectric, a device having a transmittance of 50% or higher as a whole can be formed. In the structure shown in FIG. 2, since a hollow space is formed except for the cantilever portions, an image on a video display can be observed more clearly.

By pressing or rubbing an object such as paper, cloth, leather, plastic, metal, or their artifact against the aforementioned complex functional device, the surface state of the contact object can be examined. Of course, the complex functional device can be used as a touch panel or hand-writing input device of various information processing apparatuses, or a fingerprint sensor or infrared ray sensor. The temperature detection portion can also be used as a thermometer that measures its ambient temperature if no object contacts it. Furthermore, temperature detection portions alone may be arranged to form a linear or two-dimensional temperature sensor, so as to measure the temperature distribution of a contact object.

The complex functional device according to the first or second embodiment has a function of detecting various kinds of haptic information such as temperature, pressure, and the like at the same time, and reproducing those kinds of information. Thus, an information process, which is approximate to human haptic sense, can be made in a wide variety of applications in different fields such as detection of various three-dimensional patterns, the surface states of paper and the like, an input device to an information apparatus, and the like.

(3) Third Embodiment

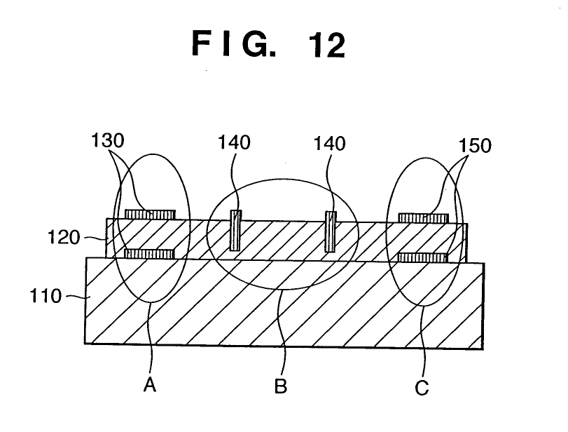

The structure of a complex functional device according to the third embodiment of the present invention will be described first using FIG. 12. FIG. 12 shows a schematic structure of a complex functional device according to the third embodiment of the present invention.

Reference numeral 110 denotes a substrate which is formed of a material such as silicon, glass, metal, plastic, or the like. If a material such as a metal, semiconductor, or the like having electric conductivity is used, an insulating member is preferably inserted between the substrate 110, and electrodes 130 and 150, which contact the substrate 110, and a metal oxide material 120. In FIG. 12, the electrodes 130 and 150 are respectively isolated, but one of a pair of electrodes may be used as a common electrode.

In a portion B, electrodes may be left upon patterning the electrodes 130 and 150, although not shown in FIG. 12. However, in the portion B, the residual electrode materials must be electrically isolated from electrodes 140. Reference numeral 120 denotes a metal oxide material, which has ferroelectricity or pyroelectricity. The present invention is not limited to a specific metal oxide material as long as it has ferroelectricity or pyroelectricity. For example, barium titanate, bismuth titanate, lithium niobate, lithium tantalate, lead zirconate titanate, lead lanthanum zirconate titanate, materials obtained by adding various metal elements to them, and their mixed crystals (e.g., Pb(Mg_{1/3}Nb_{2/3})O₃-PbTiO₃, 0.7Pb(Ni_{1/3}Nb_{2/3})O₃-PbTiO₃, 0.7Pb(Co_{1/3}Nb_{2/3})O₃-Pb(Zr, Ti)O₃, and the like) may be used.

The thicknesses and areas of the metal oxide material may be arbitrarily selected depending on the intended purposes. For example, assume that the complex functional device is mounted on a mobile information apparatus. When an arbitrary object contacts the complex functional device at a pressure ranging from 0.4 to 1.0 kg/cm², and a temperature within the range of ±20° from room temperature is to be measured, the total thickness of the metal oxide material can generally fall within the range from 0.1 μm to 1.0 mm. Reference numerals 130, 140, and 150 denote electrodes respectively used to measure a pressure in the direction of thickness of the metal oxide material 120, a pressure in the horizontal direction, and the temperature. The electrode material is a conductive material, which is not particularly limited as long as it can be formed on the substrate 110 and metal oxide material 120 and can obtain a practical contact strength.

A case will be exemplified below wherein a ferroelectric such as lead lanthanum zirconate titanate (to be referred to as PLZT hereinafter) is adopted as the metal oxide material in FIG. 12. A stacked portion of the electrodes 130 and metal oxide material PLZT 120 (to be referred to as a portion A hereinafter) can detect a pressure that vertically acts on the PLZT film 120 by exploiting piezoelectric property d₃₃ of the PLZT. Also, a portion where the PLZT film 120 is sandwiched between the electrodes 140 (to be referred to as a portion B hereinafter) can detect a pressure that acts in the plane direction of the PLZT film 120 by exploiting piezoelectric properties d₃₁, d₁₅, d₂₄, and the like of the PLZT. A portion where the electrodes 150 and PLZT film 120 are stacked (to be referred to as a portion C hereinafter) has the same structure as the portion A but this portion can detect the temperature by exploiting the pyroelectricity of the PLZT film 120. In order to detect the temperature by this portion C with high s nsitivity, a temperature absorbing member may be formed on the electrode 150, or a wavelength filter used to detect a specific wavelength alone may be formed.

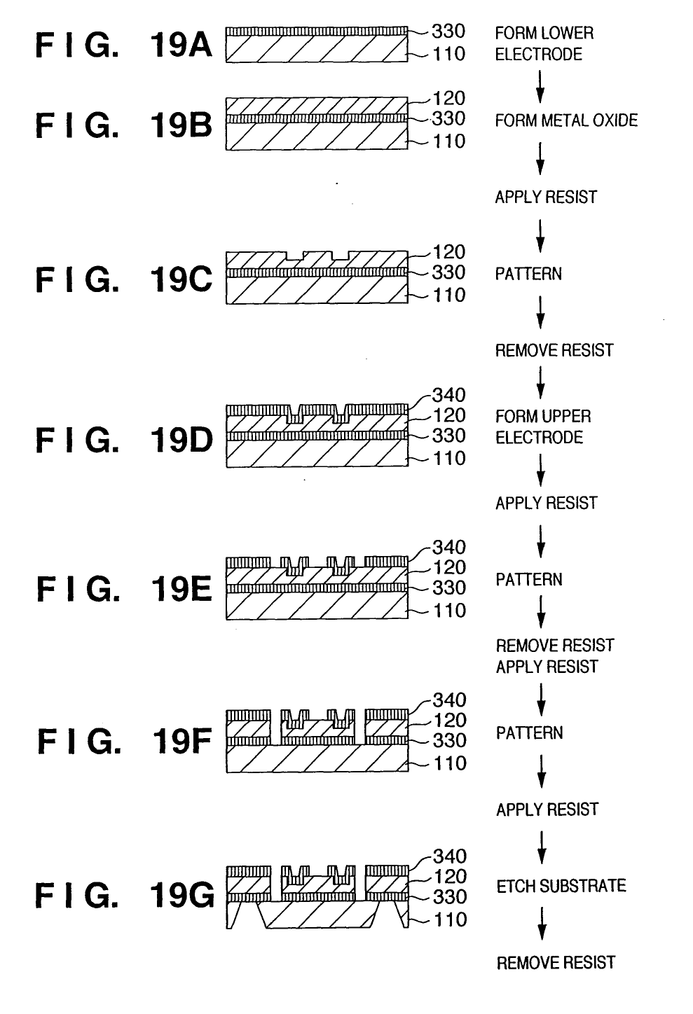

A method of manufacturing the complex functional device according to this embodiment will be described below using some of FIGS. 19A to 19G (FIGS. 19A to 19E or 19F). A silicon wafer having a 2-μm thick thermal oxide film (silicon oxide) as an insulating member was used as the substrate 110. (In FIGS. 19A to 19G, silicon and silicon oxide are not separately illustrated.) Pt/Ti (Pt: 500 nm thick, Ti: 8 nm thick) was formed as a lower electrode 330 by PF sputtering (FIG. 19A), and (Pb, La)(Zr, Ti)O₃ (to be abbreviated as PLZT 120 hereinafter) was formed as a metal oxide by RF sputtering (FIG. 19B). In this embodiment, the composition was controlled to have Pb/La=95/5 atomic %, Zr/Ti=30/70 atomic %, and the film thickness was 4 μm. The PLZT film 120 is patterned by an aqueous solution mixture of hydrofluoric acid and nitric acid using a resist (e.g., AZ4620 or the like), as shown in FIG. 19C. The etching depth of the PLZT film 120 was 500 nm. After the resist was removed by oxygen plasma, an upper electrode 340 was formed (FIG. 19D). The upper electrode 340 used the same material as the lower electrode 330 and also had the same film thickness. Then, the upper electrode 340 is patterned, and the resist is removed, thus manufacturing an element (110) of the complex functional device of this embodiment shown in FIG. 12 (FIG. 19E). Alternatively, the upper electrode 340, PLZT film 120 (metal oxide film), and lower electrode 330 may be patterned in turn to form a structure shown in FIG. 19F.

Note that FIG. 12 illustrates a structure in which the lower electrodes are isolated. In order to obtain the same structure as that in FIG. 12, a process of patterning the lower electrode formed in the manufacturing process in FIG. 19A may be added.

In general, the piezoelectric property of the ferroelectric changes depending on the crystal orientation, and its difference often becomes several times. This means that vertical and horizontal pressure detection sensitivity levels are different depending on the crystal orientation of the ferroelectric. In order to detect a delicate three-dimensional pattern on the surface of paper, cloth, or the like, the vertical and horizontal detection sensitivity levels are preferably equal to each other. However, in order to relatively roughly detect a three-dimensional pattern or to detect fingerprints or the like, the vertical detection sensitivity is often more important. Hence, this sensitivity difference does not pose any problem depending on the intended purposes. However, in the present invention, the metal oxide material may be manufactured to have uniform piezoelectric properties in the vertical and horizontal directions.

In this case, the manufacturing process shown in FIG. 19B is executed as follows. Metals which form the metal oxide (for example, four metal elements Pb, La, Zi, and Ti in case of the PLZT film 120) are evaporated from independent evaporation sources. For example, in case of RF sputtering, targets (e.g., metals, metal oxides, organometallic compounds, metal halides, or the like) which contain respective forming metals, and an oxygen supply source that supplies a substance which contains an oxygen element such as oxygen, ozone, nitrogen oxide, or the like are set in a single film formation apparatus, and are controlled to operate independently.

Upon film formation, a metal-oxygen crystal plane and oxygen crystal plane are alternately stacked on a substrate by making a substance (oxygen component) containing an oxygen element and a substance (metal component) containing a metal element alternately reach the substrate. In case of PLZT, control is made so that the composition ratio of Pb, La, Zi, and Ti has a desired value (e.g., Pb/La=95/5 atomic %, Zr/Ti=30/70 atomic %). This control method is not particularly limited. For example, a slit and shutter are inserted between each target and substrate, thus controlling the composition by the width of each slit, and achieving alternate stacking with an oxygen plane by opening/closing the shutter. Since the metal oxide film is formed in this way, a 210 crystal plane is vertically grown on the substrate. This means that the direction of polarization of the ferroelectric has a tilt of 45° with respect to the substrate. Hence, nearly equal piezoelectric properties can be obtained for pressures in both the vertical and horizontal directions.

Such film formation method is not limited to RF sputtering. If MOCVD is used, source gases may be independently supplied. In general, in case of MOCVD, since an organometallic compound is used as a source, separation of a metal component and organic component poses a problem. To solve this problem, in this embodiment, each source gas is separated by ionization or heating upon introducing into a film formation chamber, and a metal component of the source gas that has been treated in this way is accelerated using an electrode as needed, thus activating the metal component that reaches the substrate.

As a result of activation by means of ionization, heating, and acceleration, a substance having a positive charge mainly reaches the substrate as a metal component. Consequently, mixing of organic components generated by separation can be reduced. In addition, since a metal component, the kinetic energy of which is controlled by an activation condition (e.g., an acceleration voltage), has appropriate energy required for crystal growth, the obtained metal oxide material has a low film formation temperature, and its crystallinity/orientation can be controlled. Also, oxygen is activated by heating, ionization, plasma conversion, or the like to reduce the film formation temperature of the obtained metal oxide, and to control its crystallinity/orientation.

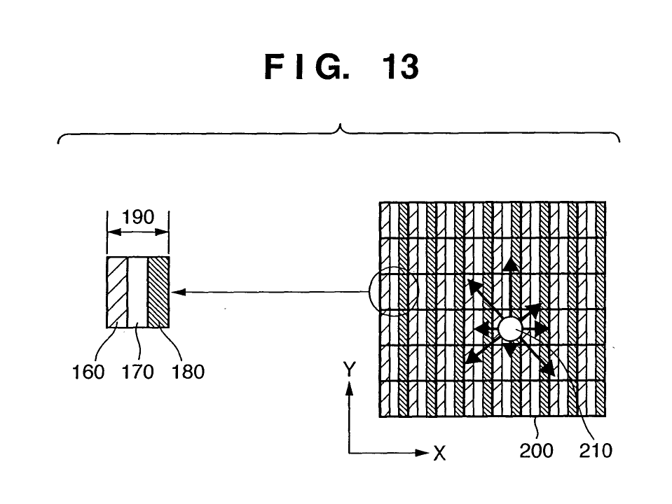

By using one element manufactured in this way or linearly, two-dimensionally, or three-dimensionally arranging such elements, haptic information, i.e., temperature and pressure information, is detected. A case will be explained below wherein the elements are arranged two-dimensionally, as shown in FIG. 13. Note that a portion 160 corresponds to the portion A in FIG. 12, a portion 170 corresponds to the portion B in FIG. 12, and a portion 180 corresponds to the portion C in FIG. 12.

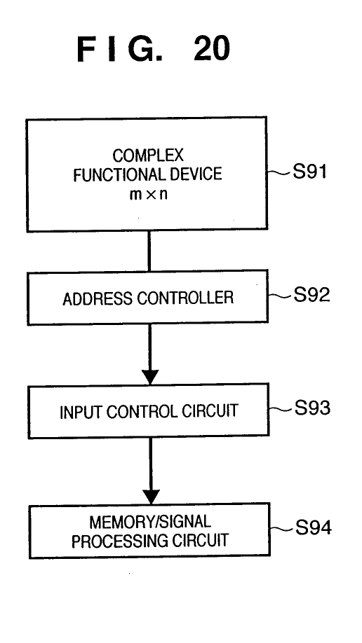

When an arbitrary object contacts a certain portion 210 of, e.g., a two-dimensional matrix of a large number of elements 200, and that object moves in various directions, as indicated by the arrows, the contact area, moving direction, temperature, and pressure information can be detected by sequentially reading the outputs from the respective elements. That is, as shown in FIG. 20, the outputs (step S91) from the complex functional device as an m×n matrix of elements undergo processes such as amplification, a noise process, and the like in the input control circuit (step S93) via the address controller (step S92). The processed signals then undergo required signal processes such as compression and the like, and are then saved in the memory/signal processing circuit (step S94). The saved data can undergo various other processes using a computer or the like (not shown) or can be transferred to another computer using communication means such as the Internet or the like or a memory medium such as a flexible disk or the like.

In FIG. 13, an element size 190 can be determined depending on the intended purposes. For example, when a fingerprint of a person is to be detected as a pressure, the pressure detection portion can have a width of about 50 μm. When the surface state of a contact material is to be examined, the element size 190 can fall within the range from 1 μm to 10 mm.

(4) Fourth Embodiment

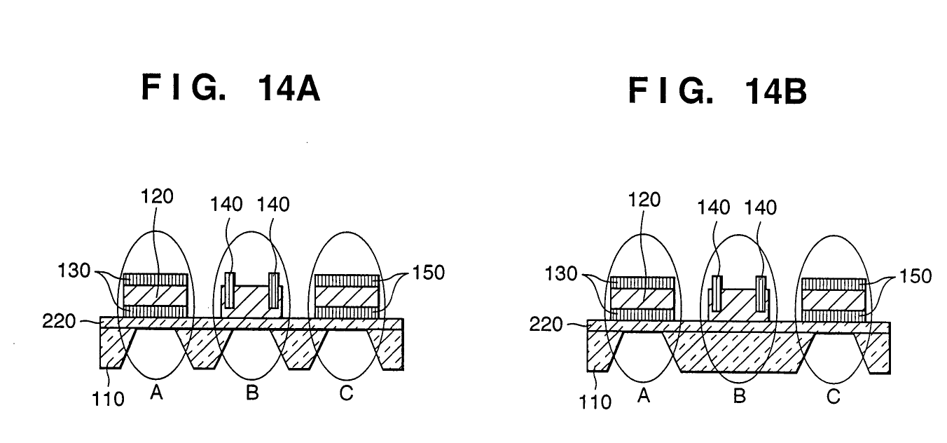

FIGS. 14A and 14B show the structure of a complex functional device according to the fourth embodiment of the present invention. In this embodiment, the metal oxide 120 is attached to an elastic member 220 via an electrode. This elastic member may be formed of a material which is either the same as or diff rent from the electrodes 130, 140, and 150, or the substrate 110. When the elastic member 220 is made up of the same material as the electrodes 130 and 150, one of the opposing electrodes (130, 150) may be thickened. When the elastic member 220 is made up of the same material as the substrate 110, it may remain unremoved by a thickness required to form a hollow space structure. This elastic member has a function of improving the mechanical strengths of respective portions, improving the detection sensitivity since it serves as a vibration plate for a vertical pressure, and preventing heat build-up since it serves as a heat sink in the temperature detection portion. The material of the elastic member is not limited to an insulating material, semiconductor, monocrystal, polycrystal, amorphous, and the like, and is not limited to an organic or inorganic material, either, as long as it is suited to such purposes.

In FIG. 14A, all portions that detect the temperature and pressures are attached to the elastic member with a hollow space structure. However, not all portions need have a hollow space structure, and a hollow space structure can be formed in an arbitrary portion. For example, as shown in FIG. 14B, a horizontal pressure detection portion B need not have a hollow space structure in consideration of the mechanical strength. Either one of these structures may be selected depending on the purposes.

The ratio of the total thickness of the stacked structure including the electrodes (the sum of the thicknesses of the electrodes on the two sides) of a vertical pressure detection portion and the metal oxide to the thickness of the elastic member can be generally electrode/stacked structure=0.5 or more, and the electrodes on the two sides need not always have the same thickness. Upon detecting a small pressure, the hollow space structure can improve the detection sensitivity since the displacement amount increases even when the pressure remains the same. Since heat readily builds up in the element of the temperature detection portion, the temperature detection portion adopts a hollow space structure to reduce the heat capacity of the detection portion, thus allowing high-speed measurement.

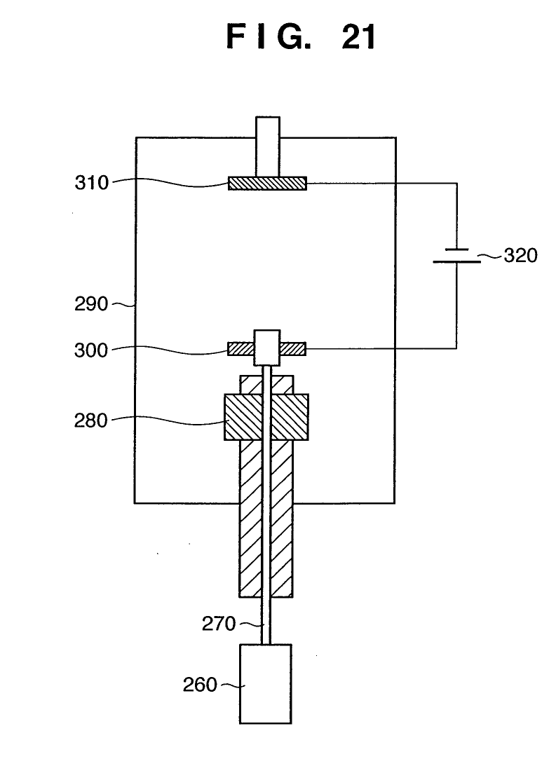

FIGS. 19A to 19G show the method of manufacturing the complex functional device according to the third embodiment. The method of manufacturing the complex functional device according to the fourth embodiment is basically the same as the aforementioned method until FIG. 19E. However, in this embodiment, the metal oxide 120 in FIG. 19B was formed by MOCVD. FIG. 21 shows the principle of activation of a source gas used in this embodiment.

Reference numeral 290 denotes a vacuum chamber, the interior of which is maintained in a reduced pressure state by an evacuation apparatus (not shown). Reference numeral 330 denotes a substrate holder, which can rotate and heat a substrate as needed using a circuit (not shown). Reference numeral 260 denotes a metal source material chamber which forms the metal oxide 120. Reference numeral 270 denotes a pipe through which a source gas that flows out from the chamber 260 flows. The source gas is activated as follows. Reference numeral 280 denotes a heater which has a role of thermally decomposing the source gas that flows along the pipe 270. This component 280 is not limited to the heater, but a plasma source or ionization source may be used. In this case, a plasma source or ionization source is inserted between an acceleration electrode 300 and the distal end portion of the source gas pipe 270. Reference numeral 300 denotes an acceleration electrode which is set to have a positive potential with respect to a substrate. Reference numeral 320 denotes a power supply.

In FIG. 21, the source chamber 260 for only one type is illustrated. However, a plurality of chambers are normally used in correspondence with metal components. In such case, in order to optimally activate respective metal components, since it is desirable to independently control an acceleration voltage, the substrate holder is set at a ground potential. Of course, all components to be used may be set at reverse potentials. It is desirable that independent components are used as respective metal components. However, many forming metals must be often be used depending on the metal oxides 120. In such case, components which belong to identical crystal sites or have similar thermal decomposition temperatures of source gases may be mixed. The source gases normally use organometallic compounds such as lead bisdipivaloylmethanate, tetra tert-butoxy Zirconium, tetraisopropoxy titanium, a lanthanum cyclopentadienyl complex, and the like, but other materials may be used. Such source material is introduced from a device (not shown) into the metal source material chamber 260 using a carrier gas such as argon or the like. In this case, the source gas is thermally decomposed using, e.g., the heater 280, and chemical species which contain a metal generated by decomposition are accelerated by the acceleration electrode 300. As a result, the chemical species which contain a metal generated by decomposition and have a positive charge are given kinetic energy and reach the substrate.

In this embodiment, all metal components Pb, Zr, Ti, and La were set in independent source chambers 260, and the acceleration voltage of the acceleration electrode 300 and the heating t mperature of the heater 280 were independently controlled. The acceleration voltage normally falls within the-range from 0 to 10 kV, and the heating temperature of the heater 280 normally falls within the range from 100 to 1,000° C. Also, as an oxygen source, an oxygen gas from an oxygen cylinder was introduced into the pipe 270 in FIG. 21, and was heated to 500° C. by the heater 280. Alternatively, ozone, oxygen nitride, or the like may be used. An oxygen source material may undergo plasma conversion or ionization in addition to heating. Film formation is done by introducing, into the vacuum chamber, e.g., the oxygen source continuously, and Pb, La, Zr, and Ti source gases periodically via a solenoid operated valve (not shown). In this case, the composition of the metal oxide is controlled by adjusting the introduction times of metal components, and a metal oxide material having a structure formed by alternately stacking an oxygen plane and a metal—oxygen plane of the crystal is formed on the substrate attached to the substrate holder 330. This structure corresponds to a (111) crystal plane grown parallel to the substrate in case of the PLZT 120.

Processes after FIG. 19E will be explained below. After the resist used in the process of FIG. 19E was removed, and a resist used to pattern the metal oxide 120 was applied, the upper electrode 340, metal oxide 120, and lower electrode 330 were sequentially patterned by dry etching (FIG. 19F). As th patterning conditions, the upper and lower electrodes 340 and 330 were patterned by dry etching using Ar plasma, and the PLZT 120 was patterned by wet etching using an aqueous solution mixture of hydrofluoric acid and nitric acid.

After the resist used at that time was removed, the silicon substrate 110 was etched (FIG. 19G). A silicon nitride film was formed as a mask by LPCVD, and was patterned using a resist (AZ1500). Then, the substrate 110 was etched using CF₄ plasma. The silicon substrate 110 was then removed using a potassium hydroxide aqueous solution. One of the device structures shown in FIGS. 14A and 14B may be selected depending on the mask pattern. By arranging elements fabricated in this way in an m×n matrix, as shown in FIG. 13, the complex functional device according to this embodiment was manufactured. A protection film may be formed on the device surface to improve durability against wear and the like.

Using the aforementioned complex functional device, a measurement system is formed by an address controller, input control circuit, and memory/signal processing circuit, as shown in FIG. 20. In this state, by pressing or rubbing an object such as paper, cloth, leather, plastic, metal, or their artifact against the complex functional device, the surface state of the contact object can be examined. Of course, the complex functional device can be used as a touch panel or hand-writing input device. The temperature detection portion can also be used as a thermometer that measures its ambient temperature if no object contacts it. Furthermore, temperature detection portions alone may be arranged to form a two-dimensional temperature sensor, so as to measure the temperature distribution of a contact object.

(5) Fifth Embodiment

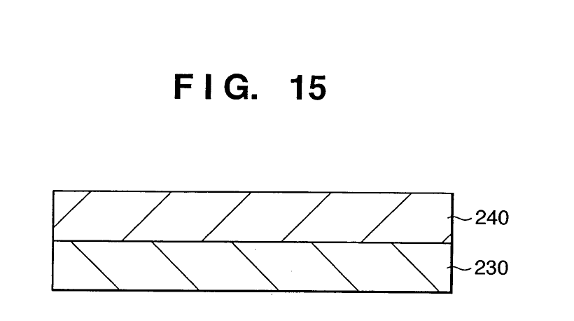

FIG. 15 shows the structure of a complex functional device according to the fifth embodiment of the present invention.

Reference numeral 230 denotes a display device for displaying video information. This device can use any of various still images such as a silver halide photo, poster, and the like, a CRT, organic EL, inorganic EL, various liquid crystal devices, and the like, which display moving images. The sectional shape need not be a flat shape shown in FIG. 15, and may be a shape having a curved surface such as a semi-spherical shape or the like.

Reference numeral 240 denotes a complex functional sensor portion for detecting temperature and pressure information. As the sectional structure of the portion 240, any of the structures shown in FIG. 12 and FIGS. 14A and 14B, and their modified structures may be adopted. For xample, when the video display 230 comprises a liquid crystal color display, typical one pixel size is 330 μm×330 μm. The substrate 100 is made up of a transparent material such as glass or the like, the electrodes adopt transparent electrodes formed of ITO, ZnO, or the like, and the metal oxide is made up of a transparent ferroelectric or pyroelectric such as PZT, barium titanate, or the like.

The complex functional sensor portion is stacked on a video display surface of the video display, and the video display surface makes video display based on information detected using the complex functional sensor portion.

The electrode is manufactured by a normal thin film formation method such as sputtering or the like, and is patterned to a desired pattern. For example, the metal oxide is divided into three portions in correspondence with one pixel size of the video display 230, and each of temperature and pressure detection has a size of 110μm×330 μm. These portions respectively detect the vertical and horizontal pressures and temperature. Of course, the temperature and pressure detection portions may be divided to have sizes other than that described above depending on the intended purposes.

With this structure, for example, when a person approaches the temperature detection portion, that portion can detect the body temperature of that person, and can turn on the switch of the video display. Wh n the same object as that displayed on the video display is brought into contact with the pressure detection portions, surface information of that object can be detected.

B. Actual Example

Actual examples of the respective embodiments will be explained below. In the fourth and fifth embodiments, the metal oxide 2 is divided into three portions, but may be divided into two or four portions. Also, the device manufacturing method is not limited to means to be described below, and may be selected in correspondence with materials which form a device.

(1) Actual Example 1

In the haptic information element shown in FIG. 1, an elastic member 4 and substrate 5 denote identical materials, i.e., silicon monocrystals, which were obtained by working a (100) surface extracted from the crystal by anisotropic etching to have a sectional shape shown in FIG. 1. Reference numeral 3 denotes a metal oxide, which used (Pb, La)(Zr, Ti)O₃ (to be abbreviated as PLZT hereinafter). In the present invention, the composition was adjusted to have Pb/La=95/5 atomic %, and Zr/Ti=30/70 atomic %. Reference numerals 1 and 2 denote electrodes, which used titanium/platinum stacked electrodes.

The method of fabricating the haptic information element will be describ d below. As shown in FIGS. 10A to 10H, a silicon oxide film was formed on the substarte of silicon monocrystal 5 by thermal oxidation to obtain an elastic member 4. A 20-nm thick titanium film and 200-nm platinum film were successively formed as the electrode 2 by RF sputtering. A 5-μm thick PLZT film was formed on this electrode by PF sputtering. The PLZT film and electrode 2 were patterned by dry etching, and a 1-μm deep groove was formed in a horizontal pressure detection portion. Finally, the substrate 5 was etched from its back surface by anisotropic etching to form a hollow space structure, and was connected to an external circuit (not shown) via lines (not shown), thus manufacturing an element.

In order to confirm the function of this complex functional device, 300 haptic information elements were linearly arranged to form a line sensor, as shown in FIG. 4. In this case, since the three portions have a width of 50 μm and a length of 300 μm, the sensor portion of the complex functional device as a linear array of the fabricated elements has a total width of 45 mm.

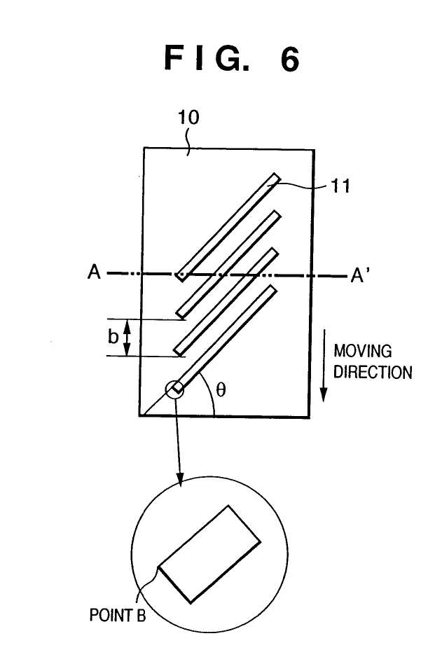

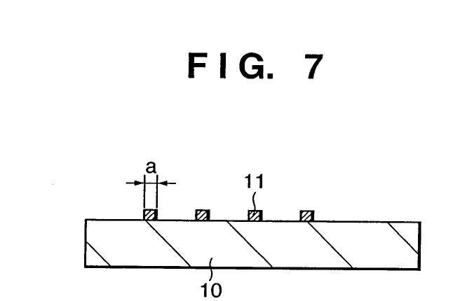

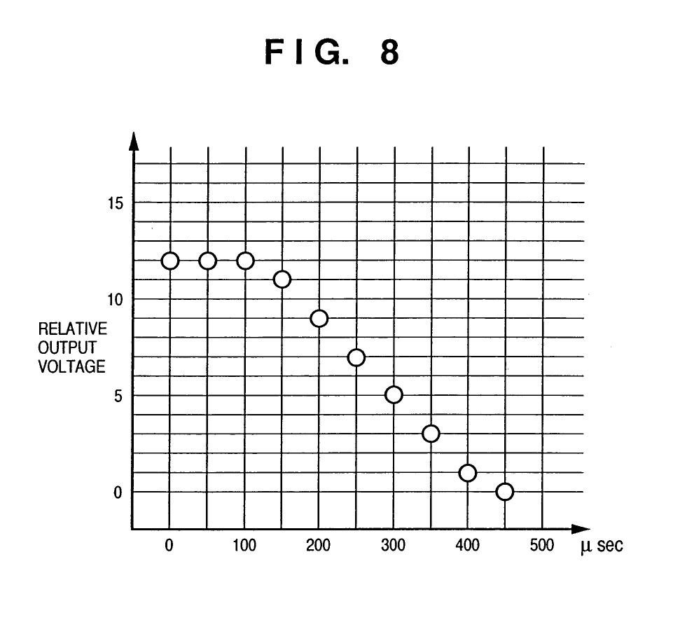

A silicon wafer was etched to form a straight line stripe pattern (width a=300 μm, height=4 μm, spacing b=1 mm, and θ=45°) (FIG. 7 is a sectional view taken along a line A-A′ in FIG. 6), as shown in FIG. 6. Such silicon wafer was brought into contact with the sensor portion at a pressure of 0.5 kg/cm². At this time, the sensor portion was moved in a direction of the arrow in FIG. 6 at a speed of 50 μm/sec while point B (pattern edge portion) in FIG. 6 matched the left end of the sensor portion. Signals were read by the input control circuit 22 in FIG. 9. At this time, the output from the vertical pressure detection portion of the haptic information element arranged at the left end changed, as shown in FIG. 8, and it was confirmed that the output proportional to the contact area between the stripe pattern and haptic information element could be obtained.

Furthermore, the outputs from respective haptic information elements were sequentially changed from the left end to the right end of the sensor portion in correspondence with the movement of the sensor portion. After that, upon touching the sensor with a finger while applying a voltage to the cantilever portions from the output control circuit 25 in FIG. 9, up-and-down vibrations could be sensed. Also, it was confirmed that the up-and-down vibrations moved from the haptic information element at the left end to that at the right end to reproduce a change in output from the respective elements along with an elapse of time.

(2) Actual Example 2

FIG. 2 shows the principle of the sectional structure of the haptic information element, and FIGS. 11A to 11I show the fabrication sequence.

In FIG. 2, a substrate 5 was made up of photosensitive glass, and an elastic member 4 used the same material as the substrate 5. Reference numerals 1 and 2 denote electrodes. The electrode 2 adopted a Cr/Ti/Pt structure, and the electrode 1 formed via a metal oxide 3 adopted a Ti/Pt structure. These electrodes were formed by PF sputtering. In this example, the metal oxide was 0.7Pb(Mg_{1/3}Nb_{2/3})O₃-0.3PbTiO₃, and was formed by the sol-gel process. The elastic member 4 had a thickness of 5 μm, and the metal oxide 3 had a thickness of 6 μm. The substrate 5 and elastic member 4 were patterned by normal wet etching, and the electrodes 1 and 2, and the metal oxide 3 were patterned by normal dry etching. A cantilever portion to which the electrode 1/metal oxide 3/electrode 2 are attached has a length of 300 μm, and a width of 80 μm. Four cantilevers were arranged at 90° angular intervals.

In order to examine the performance of this haptic information element, the elements were arranged in a 100×100 matrix to form a two-dimensional sensor. A polymer protection film was formed to cover the entire sensor to be separated 0.1 mm from the surface of this two-dimensional sensor. The electrodes 1 and 2 were connected via lines to the input control circuit, output control circuit, memory/arithmetic processing circuit, and communication circuit via the address controller 21, as shown in FIG. 9.

Commercially available copy paper sheets FB75 (available from FoxRiverBond) and Xx90 (available from Xerox) were brought into contact with the complex functional device of this example at a pressure of about 0.8 kg/M² for 5 sec. After that, the device was moved at 0.5 s/cm for 10 sec in the X-direction in FIG. 5. At this time, upon measuring the outputs from the vertical pressure detection portions based on the contact for 5 sec, the maximum output variation was 32.2% for FB75.

By contrast, the outputs from the horizontal pressure detection portions had a large output variation, and the variation width was relatively about 25%. On the other hand, the relative variation width of the outputs from Xx90 was about 15% in the vertical direction, and a variation of 10% was observed based on the pressure in the horizontal direction. By estimating a temperature rise due to the movement in the X-direction on the basis of the outputs from the temperature detection portion, a maximum temperature rise of 3.5° C. was observed for FB75. In case of Xx90, a maximum temperature rise of 1.2° C. was observed. Upon observing the surfaces of these copy paper sheets by a laser microscope, FB75 had a roughness of approximately 9.3 μm, and large undulations of several 10 to 100 μm were observed. Xx90 had a roughness of about 8.9 μm, and the undulation pitch was about several 10 microns or less. These facts match the measurement results of the complex functional device of this example, and reveal that the surface of FB75 has larger roughness than Xx90 on the whole paper sheet.

On the basis of the detection voltages of the respective haptic information elements upon contacting in the vertical direction for 5 sec, the output control circuit applied voltages from an external power supply to the stacked structures formed on cantilevers so as to bend the cantilevers upward. In this state, when the sensor surfaces was traced with a finger, roughness was strongly sensed for FB75, and Xx90 was relatively flat. This interval was similar to a roughness interval when these paper sheets was clipped and rubbed between fingers.

(3) Actual Example 3

FIG. 12 shows the principle of the sectional structure of one element according to the third embodiment of the present invention. In FIG. 12, reference numeral 110 denotes a silicon wafer (substrate), which used one obtained by extracting a (100) surface. Reference numeral 120 denotes a metal oxide, which used (Pb, La)(Zr, Ti)O₃ (to be abbreviated as PLZT hereinafter). In this embodiment, the composition was adjusted to have Pb/La=95/5 atomic % and Zr/Ti=30/70 atomic %.

FIGS. 19A to 19E show the manufacturing method. After the surface of the silicon wafer was thermally oxidized to form a silicon oxide film, a titanium/platinum stacked electrode was formed (titanium: 15 nm thick, platinum: 150 nm thick) by RF sputtering. After that, the resultant structure was patterned by a normal semiconductor fabrication technique to leave only portions of electrodes 130 and 150.

Then, a 3-μm thick PLZT film was formed by MOCVD. The source gases of respective metal component used lead bisdipivaloylmethanate, tetra tert-butoxy zirconium, tetraisopropoxy titanium, and a lanthanum cyclopentadienyl complex. Four source chambers in FIG. 21 were prepared, and the organic metals were individually filled in these chambers.

For Ti and Zr components, the heater 280 was heated to 300° C. For Pb and La components, the heater 280 was set at 400° C. The acceleration voltage for the Pb and La components was 2 kV, and that for the Zi and Ti components was 3 kV. The metal composition was controlled by controlling the flow rate of an argon gas introduced into the source chambers 260. The substrate temperature was set at 600° C., and a metal oxide film (PLZT film) 120 was formed while rotating the substrate 330 revolutions per sec. It was confirmed by X-ray diffraction of the metal oxide film (PLZT film) 120 formed in this way that a <111> crystal plane was grown perpendicularly to the substrate (<111> orientation film). On the other hand, if no acceleration voltage was applied to all metal components, a <001> crystal plane was oriented perpendicularly to the substrate (<001> orientation film).

A prospective formation portion of the electrode 140 of the <111> orientation film was etched to a depth of 2.5 μm by wet etching using hydrofluoric acid and nitric acid. After that, the upper electrode formed of titanium and platinum was formed on the entire surface by RF sputtering, and was patterned to separate the electrodes 130, 140, and 150. The electrodes 130, 140, and 150 were connected to the address controller, input control circuit, and memory/arithmetic circuit via lines, as shown in FIG. 20, thus manufacturing a complex functional device according to this embodiment. An insulating protection film may be formed on the entire surface of the element. In this embodiment, the three portions had a width of 50 μm and a length of 300 μm, and 300 elements were linearly arranged. Hence, the sensor portion of the manufactured complex functional device has a width of 45 mm.

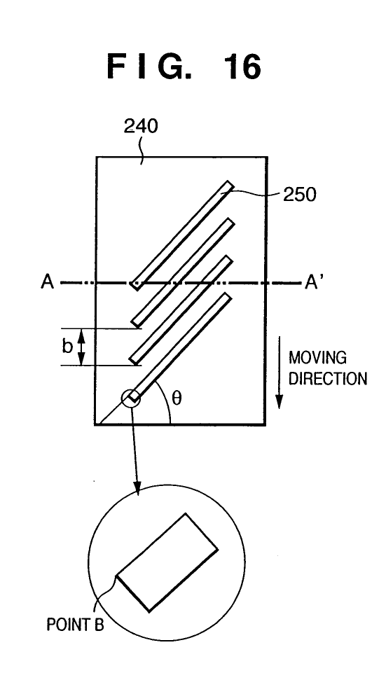

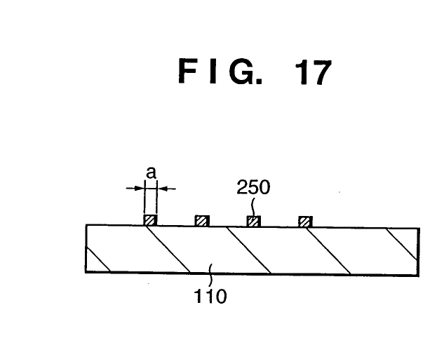

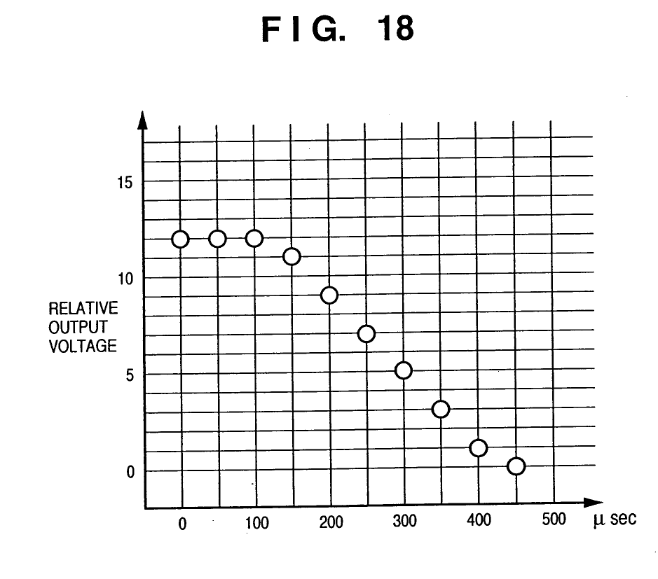

A silicon wafer was etched to form a straight line stripe pattern (width a=300 μm, height=4 μm, spacing b=1 mm, and θ=45°), as shown in FIGS. 16 and 17. Such silicon wafer was brought into contact with the sensor portion at a pressure of 0.9 kg/cm². At this time, the sensor portion was moved in a direction of the arrow in FIG. 16 at a speed of 50 μm/sec while point B (pattern edge portion) in FIG. 16 matched the left end of the sensor portion. At this time, the output from the vertical pressure detection portion (pressure detection element) of the element arranged at the left end changed, as shown in FIG. 18, and it was confirmed that the output proportional to the contact area between the straight line pattern and vertical pressure detection portion could be obtained. On the other hand, the output voltage from the horizontal pressure detection portion was about 80% of the vertical pressure detection portion, but its relative output showed the same tendency as in FIG. 18. Even when the pressure on the silicon pattern was reduced to 0.1 kg/cm², it was possible to detect signals in both the vertical and horizontal directions.

For the sake of comparison, a device was manufactured using the <001> orientation film by the same method as the <111> orientation film, and similar experiments were conducted. The relative outputs in both the vertical and horizontal directions were the same as those in FIG. 18. However, the output voltage from the horizontal direction was about ⅓ that in the vertical direction, and when the pressure on the silicon pattern was reduced to 0.3 kg/cm² or less, horizontal pressure detection was disabled.

As described above, the complex functional device of this embodiment could detect the vertical and horizontal pressures irrespective of the PLZT orientation. It was confirmed that the pressure detection limit could be corrected by controlling the orientation.

(4) Actual Example 4

FIGS. 14A and 14B show the principle of the sectional structure of a complex functional device according to the fourth embodiment of the present invention. In FIGS. 14A and 14B, a substrate 110 was made up of photosensitive glass, and an elastic member 220 used the same material as the substrate 110. Reference numerals 130, 140, and 150 denote electrodes. The electrode which contacted the elastic member 220 adopted a Cr/Ti/Pt structure, and the counter electrode formed via a metal oxide 120 adopted a Ti/Pt structure. These electrodes were formed by PF sputtering.

The metal oxide was 0.7Pb(Mg_{1/3}Nb_{2/3})O₃-0.3PbTiO₃, and was formed by the sol-gel process. The elastic member 220 had a thickness of 5 μm, and the metal oxide 3 had a thickness of 5 μm. The substrate 110 and elastic member 220 were patterned by normal wet etching, and the electrodes, and the metal oxide were patterned by normal dry etching. One element siz is specified by a width of 180 μm and a length of 500 μm, and this element is divided into three portions A, B, and C, as shown in FIGS. 14A and 14B: a portion A detects a vertical pressure, a portion B detects a horizontal pressure, and a portion C detects a temperature. Such elements were arranged in a 200×200 matrix, and the entire matrix was covered by a polymer protection film. The electrodes 130, 140, and 150 were connected to the arrangement shown in FIG. 20 via lines to obtain a complex functional device of this embodiment.

Commercially available copy paper sheets FB75 (available from FoxRiverBond) and Xx90 (available from Xerox) were brought into contact with the complex functional device of this embodiment at a pressure of about 0.8 kg/m². After that, the device was moved at 0.5 s/cm for 10 sec in the X-direction in FIG. 13. In case of FB75, the relative outputs from the vertical pressure detection portions had a maximum error of 15.8%. By contrast, the outputs from the horizontal pressure detection portions suffer a large output variation, and a variation width was relatively about 30%.

On the other hand, a relative variation width of the outputs for Xx90 was about 8.9%. However, when the device was moved in the Y-direction in FIG. 13, no difference between the two different paper sheets was detected. By stimating a temperature rise due to the movem nt in the X-direction on the basis of the outputs from the temperature detection portion, a maximum temperature rise of 2.5° C. was observed for FB75. In case of Xx90, a maximum temperature rise of 1.4° C. was observed.

Upon observing the surfaces of these copy paper sheets by a laser microscope, FB75 had a roughness of approximately 9.3 μm, and large undulations of several 10 to 100 μm were observed. Xx90 had a roughness of about 8.9 μm, and the undulation pitch was about several 10 microns or less. These facts match the measurement results of the complex functional device of this example, and reveal that the surface of FB75 has larger roughness than Xx90 on the whole paper sheet.

(5) Actual Example 5

FIG. 15 shows the sectional structure of a complex functional device according to the fifth embodiment of the present invention. Reference numeral 230 denotes a display device for displaying video information; and 240, a complex functional sensor portion which can simultaneously detect temperature and pressure information. FIGS. 14A and 14B show the principle of the sectional structure of one element of this portion. The display device 230 is not particularly limited as long as it can display video information. For example, a video display device using an organic material such as a liquid crystal display, organic EL, or the like, a normal CRT, and the like may be used. The display device 230 need not always have a rectangular sectional shape shown in FIG. 15, and need only be stacked on the sensor portion. In this embodiment, a liquid crystal color display (one pixel has a size of 330 μm×330 μm) was used to display video information. The screen size is 12″.

In FIGS. 14A and 14B, a substrate 110 was made up of photosensitive glass, and a metal oxide 120 used (Pb, La)(Zr, Ti)O₃. In this embodiment, the composition was adjusted to have Pb/La=95/5 atomic % and Zr/Ti=30/70 atomic %. An elastic material 220 was formed of the same photosensitive glass as the substrate 110. Electrodes 130, 140, and 150 used a material obtained by doping gallium 3% to zinc oxide, and were formed by RF sputtering to have a thickness of 150 nm.

The metal oxide film 120 was formed while independently evaporating respective metal components by electron beam deposition, and blowing a plasma-treated oxygen gas onto the substrate 110 at the same time. The composition control of the metal components were made by changing the irradiation time of an electron beam. The film thickness was 10 μm. After that, the metal oxide film and lower electrode were patterned by ion milling to have a size of 100 μm ×300 μm.

Furthermore, a 5-μm depth groove was formed by ion milling in the horizontal pressur det ction portion. This groove is formed along the widthwise direction in FIGS. 14A and 14B, but may be formed along the longitudinal direction. In this embodiment, grooves were formed at two positions 15 μm separated from the edges of the metal oxide film in the widthwise direction, and each groove had a size of 10 μm×250 μm. A gallium-doped zinc oxide film was formed as an upper electrode on the entire surface by PF sputtering, and the upper electrode, metal oxide film 120, lower electrode were patterned in turn to respectively form the vertical pressure, horizontal pressure, and temperature detection portions.

Finally, the back side of the substrate 110 corresponding to the temperature and pressure detection portions was removed by wet etching to form a hollow space structure. In this case, the electrodes 130 and 150 were prevented from being exposed, since a portion of the photosensitive glass was used as the elastic member. The sensor portion used to detect the pressures and temperature shown in FIGS. 14A and 14B and an IC circuit (not shown) used to process signals from the sensor portion were connected via lines using the same gallium-doped zinc oxide film as the electrodes 130, 140, and 150 on a portion where they did not overlap the video display portion of the video display. Also, in FIG. 15, the liquid crystal color display 230 and the complex functional s nsor portion 240 for detecting the temperature and pressures were adhered to each other by an adhesive so that pixels of the display 230 overlapped the elements of the sensor portion 240.

Upon drawing a line on the temperature/pressure detection portion (sensor portion) 230 of this embodiment manufactured in this way using a paint brush used to create a picture, the writing pressures, line widths, and brush moving directions could be detected in correspondence with the pressures acting on the brush and movements by processing detection signals of the respective detection portions. Since a portion with a high writing pressure generates a large heat value due to friction, a delicate change in writing pressure can be detected by combining the detection outputs of the vertical pressure and temperature. This information can be displayed on the video display 230.

Using the complex functional device according to the embodiment of the present invention, the temperature and pressure can be detected at the same time. A complex functional device which can be used in a wide variety of applications in different fields such as detection of various three-dimensional patterns, the surface states of paper and the like, an input device to an information apparatus, and the like can be provided.

The complex functional device according to the embodiment of the present invention uses a ferroelectric or pyroelectric which responds to both the temperature and pressure, and the ferroelectric or pyroelectric is divided into a plurality of portions, so that each portion can handle required information. Furthermore, since detection elements used to detect the temperature and pressure are formed in a single layer, the device manufacturing process can be greatly simplified compared to a case wherein respective detection elements are formed using different materials.

Furthermore, since a device is manufactured by controlling the crystal orientation of the ferroelectric or pyroelectric, sensitivity variations for pressures from different directions can be eliminated. Since the ferroelectric or pyroelectric is normally nearly transparent with respect to visible light, haptic information (temperature and pressure) and the video information can be handled simultaneously.

In the above description, the complex functional device according to the embodiment of the present invention can detect the temperature and pressure of an object. Also, by exploiting the physical properties of the ferroelectric or pyroelectric, the acceleration, angular acceleration, and the like of an object can be detected.

Furthermore, according to the embodiment of the present invention, the metal oxide film is divided into a plurality of portions, and the electrodes provided to the divided portions detect a plurality of different kinds of information. Hence, even when one detection element is damaged, the functions of other detection elements can be assured. In addition, since the detection elements are formed using the same material, the manufacturing process can be simplified.

<Information Input/output Apparatus with Complex Functional Device>

Next, an information input apparatus using the complex functional device described so far will be described in detail below. That is, a case will be explained wherein the complex functional device is built in the information input apparatus as a fingerprint detector.

In recent years, along with the development of the communication network society, communication networks and information processing apparatuses connected to them are being integrated. For example, the necessity of a security function such as personal authentication of users who use the information processing apparatuses is increasing.

As such personal authentication method, various authentication methods are available, and authentication that utilizes haptic information such as fingerprints and the like is especially receiving a lot of att ntion. Authentication based on haptic information (biometric information) is characterized in that there is no possibility of spoofing (an unauthentic user authenticates in place of an authentic user) and loss of physical media such as keys, recording media (e.g., IC cards) that record personal identification information, and the like.

In fingerprint personal authentication, a system for reading the fingerprint includes, for example, a system for recognizing the fingerprint from an image obtained by sensing a finger using an optical system, a system for measuring physical quantities such as heat, force, and the like obtained from a finger using a sensor, and recognizing the fingerprint on the basis of the distribution of such measured quantities, and the like, as described in “Thermal Type Fingerprint Sensor Having Arrayed Heater Elements (Abstracts of lectures at Symposium on Sensors, Micromachines and Applied Systems).

Also, as described in, e.g., Japanese Patent No. 3258632, a technique that authenticates the fingerprint and applies the authentication result to a security function is known. With this technique, a fingerprint reader is provided to a power switch or operation switch of an electronic apparatus to read the fingerprint upon power ON or startup of the electronic apparatus, thus succeeding in accurately associating biometric authentication bas d on fingerprint information with the startup operation of the electronic apparatus.

If it is determined as a result of fingerprint authentication by the fingerprint reader that a user who operates the electronic apparatus is not an authentic user who is registered in advance, the electronic apparatus restrains its own startup operation to eliminate use of the electronic apparatus by that unauthentic user.

In this manner, restraining the startup operation itself of the electronic apparatus can improve security compared to a case wherein an authentication apparatus based on biometric information is independently equipped, and the functions of the electronic apparatus are limited in accordance with the authentication result of that authentication apparatus.

As another example of a technique that authenticates the fingerprint, and applies the authentication result to the security function, for example, Japanese Patent Laid-Open No. 2000-293253 has proposed a technique for reading a fingerprint on a fingerprint reading coordinate position designated by a coordinate designation means, and controlling the operation of an electronic apparatus on the basis of a comparison result between the read fingerprint and fingerprint information registered in advance.

The electronic apparatus described in Japanese Patent Laid-Open No. 2000-293253 determines whether or not a user (operator) is authentic, using the designated fingerprint reading coordinate position and information obtained from the fingerprint authentication result independently or together, thus controlling its own operation.

More specifically, a user's intention to the electronic apparatus (user's operation instruction to the electronic apparatus) is recognized based on the designated fingerprint reading position, and a user is specified by fingerprint authentication. Then, the operation of the electronic apparatus is controlled by associating information that pertains to the specified user, and the recognized user's intention.

As an actual example of such authentication method, a method of affixing, when the fingerprint reading coordinate position is designated in a seal field of a given format, an approval seal corresponding to the user who has been authenticated is known.

An application example of the personal authentication result based on fingerprint information or the like is not limited to security-associated techniques. For example, this personal authentication is applied to, e.g., determination of the type and contents of service information provided to each individual user by associating the authentication result with information about user's interests and favorites.

However, the electronic apparatus with the fingerprint authentication function (the electronic apparatus that manages personal authentication by providing the fingerprint reader to the power switch or operation switch of the electronic apparatus) described in Japanese Patent No. 3258632 suffers the following problems.

That is, in the electronic apparatus with the fingerprint authentication function, the fingerprint reader is provided to its power switch or operation switch to give priority to security. As a result, the fingerprint reader must be provided to all switches that the user may operate.

Upon providing an ordinary service that does not require any security check to the user, the power supply of the electronic apparatus must be turned on or started up. For this reason, when a plurality of users share the electronic apparatus, each user must go to a specific place where the switch is provided, so as to undergo fingerprint authentication. Therefore, the operability of the user who uses the electronic apparatus is poor, thus forcing the user to make complicated operations.

On the other hand, the conventional electronic apparatus which reads a fingerprint at the fingerprint coordinate position, and controls its operation on the basis of the collation result of the read fingerprint with fingerprint information registered in advance, as described in Japanese Patent Laid-Open No. 2000-293253, suffers the following problems.

That is, since the conventional electronic apparatus comprises a display means, fingerprint reading coordinate designation means, fingerprint reading means, and the like, when the user touches the fingerprint reading coordinate positions on the electronic apparatus with fingers, the contact coordinate positions of the plurality of fingers of the user are presented to the user using only visual information provided by the electronic apparatus.

Also, the user's intention (user's operation instruction to the electronic apparatus) upon touching the electronic apparatus with the finger, and the user authentication result are presented to the user only when the electronic apparatus operates normally.

For this reason, the user cannot directly confirm if his or her operation to the electronic apparatus is actually made, and can only indirectly confirm that his or her operation is actually delivered to the electronic apparatus with reference to whether or not the operation on the electronic apparatus side terminates normally.

In this way, the user cannot determine whether or not his or her operation instruction can be actually delivered to the electronic apparatus, until he or she can confirm some operation end information or operation continuation information from the electronic apparatus side, with which the user can determine that the electronic apparatus has completed the operation that the user intended or quits with an incomplete operation.

Hence, an information input/output apparatus of the present invention solves the aforementioned problems. Embodiments that can solve the above problems will be described below.

<Embodiment of Information Input/output Apparatus>

Embodiments of the information input/output apparatus will be described below with reference to the accompanying drawings.

(1) First Embodiment

(Arrangement of Information Input/output Apparatus 100)

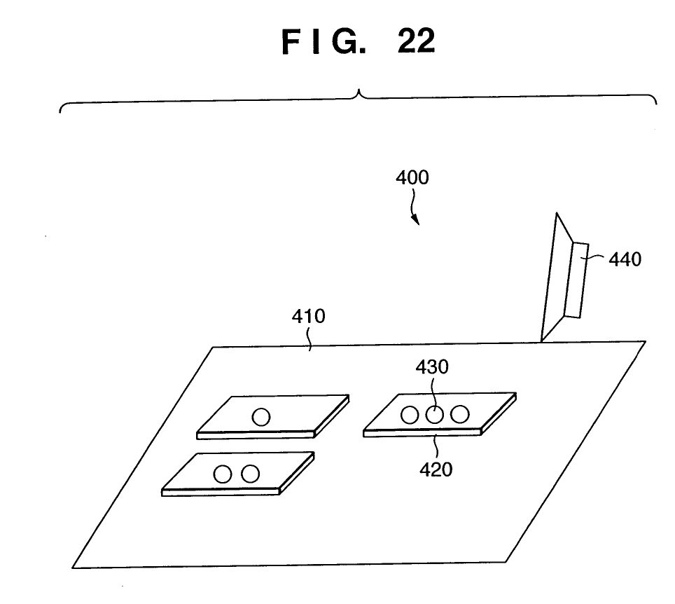

FIG. 22 is a view for explaining the arrangement of an information input/output apparatus 400 according to the first embodiment. Reference numeral 410 denotes an apparatus display & input unit; 420, selectable dummy buttons; 430, display portions indicating the contents of the dummy button 420; and 440, a loudspeaker that provides audible information.

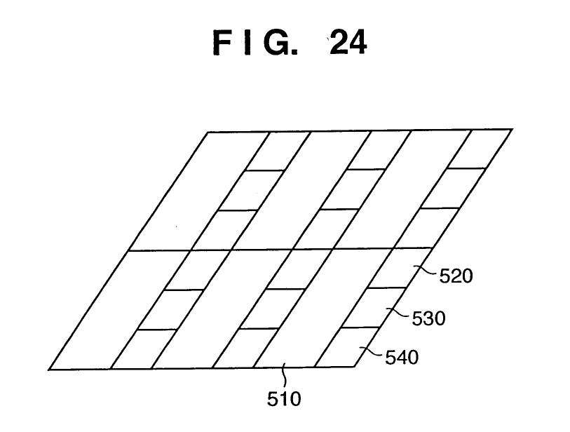

The apparatus display & input unit 410 detects the fingerprint of the user (operator) and presents information indicating whether or not the apparatus side has recognized the user's operation to the user. FIG. 24 shows an example of the layout of haptic display elements which form the apparatus display & input unit 410.

As shown in FIG. 24, reference numeral 510 denotes a haptic information output portion; and 520, 530, and 540, haptic information input portions. The apparatus display & input unit 410 adopts the following arrangement. That is, an output portion (haptic information output portion 510) and input portions (haptic information input portions 520 to 540) are combined to form one unit, and such units are arranged in a matrix.

Also, as shown in FIG. 24, haptic elements included in the haptic information output portion 510 and haptic information input portions 520 to 540 need not always have the same size. These haptic elements may have appropriate sizes in correspondence with the functions of the haptic information output portion 510 and haptic information input portions 520 to 540, as long as the resolution required to detect the user's fingerprint is assured.

Especially, upon comparison between the pitch of the haptic display elements (haptic information input portions 520 to 540) and that of the haptic display elements (haptic information output portion 510), the function of the haptic information output portion can be achieved if its pitch is larger than that of the input portions.

This is because the input portions must have a sufficiently small pitch to prevent fingerprint detection errors. By contrast, since the output portion presents information used to confirm if the user's operation is actually delivered to the apparatus side, the pitch required to present information need only be assured.

Referring back to FIG. 22, the dummy buttons 420 are selection buttons that the information input/output apparatus 400 presents to the user, and deliver user's operation, intention, and the like to information input/output apparatus 400.

Each display portion 430 concisely displays the operation contents to be executed by the information input/output apparatus 400 on the corresponding dummy button 420 when the user has pressed that dummy button 420.

The loudspeaker 440 is an acoustic device for providing audible information (information such as an operation guidance or the like) to the user.

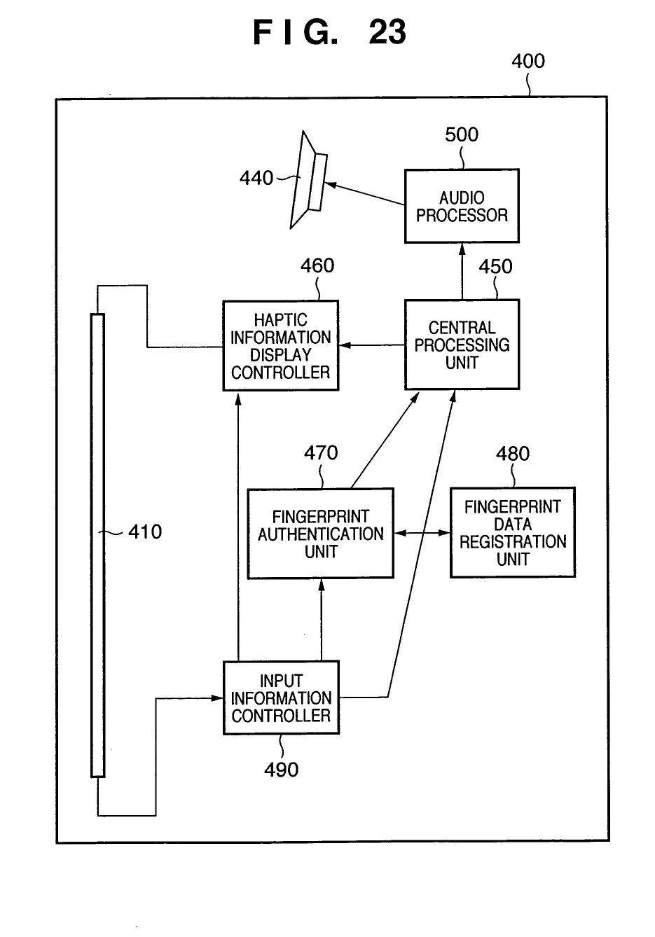

The functions of the information input/output apparatus 400 will be described below using the functional block diagram shown in FIG. 23.

A central processing unit 450 controls the op ration of the overall information input/output apparatus 400. Upon reception of user authentication information from a fingerprint authentication unit 470 or user's intention information from an input information controller 490, the central processing unit 450 controls an audio processor 500 to provide guidance information or the like to the user. The central processing unit 450 outputs a user authentication result or the like to a haptic information display controller 460.

The haptic information display controller 460 controls the operation to display the user authentication result or the like output from the central processing unit 450 on the apparatus display & input unit (haptic information display elements) 410 shown in FIG. 22.

The fingerprint authentication unit 470 determines whether or not the user's fingerprint output from the input information controller 490 matches an already registered fingerprint.

A fingerprint data registration unit 480 registers and records the fingerprint of an authentic user, so as to allow fingerprint authentication by the fingerprint authentication unit 470.

The input information controller 490 outputs the user's fingerprint and user's intention (user's operation instruction to the apparatus) obtained from the haptic information display elements 410 to the fingerprint authentication unit 470, c ntral processing unit 450, and haptic information display controller 460.

The haptic information display elements 410 include haptic elements, each of which comprises the haptic information output portion 510, haptic information input portions 520 to 540, and the like shown in FIG. 23.

The audio processor 500 executes a process for outputting predetermined guidance information via the loudspeaker 440. The audio processor 500 also executes a process for audibly delivering, via the loudspeaker 440, a result indicating whether or not the information input/output apparatus 400 has recognized the user's operation.

(Operation of Information Input/output Apparatus 400)

The operation of the information input/output apparatus 400 when the user designates a desired operation in a target apparatus will be described below.

The user selects a menu item from a menu list displayed on the target apparatus in accordance with an operation guidance output from the loudspeaker 440 of the information input/output apparatus 400.

The user recognizes the display portions 430 of the dummy buttons 420 which are further displayed on the apparatus display & input unit 410 in correspondence with the menu item of his or her choice, and presses a target dummy button 420. Note that each display portion 430 displays the contents of the corresponding dummy button 420. With this user's operation, the information input/output apparatus 400 recognizes the user's intention, and authenticates the user.

The apparatus display & input unit will be described in more detail below. A screen of the unit serves a control panel on which the contents to be operated are displayed. The dummy buttons 420 are artificial buttons (not real button switches) which can be recognized as button by touch, and their surfaces have the display portions 430 which can also be recognized by touch. In FIG. 22, since there are three circles (◯) on the dummy button 420, the contents indicating the third button or “3” are displayed as haptic information. The contents indicated by these three circles correspond to those of the dummy button 420.

As described above, the information input/output apparatus 400 comprises the functional blocks shown in FIG. 23. Upon starting an authentication process, the central processing unit 450 outputs instructions and commands required to exchange information (operation instruction information, fingerprint information, and the like) with the user to the respective units.

When the information input/output apparatus 400 is simply designed to implement only the information input/output function with the user, the central processing unit 450 has a connection interface function with an apparatus outside the information input/output apparatus 400 in addition to the aforementioned functions.

In this embodiment, the audio processor 400 functions under the operation control of the central processing unit 450, and audibly provides an operation purpose and sequence and choices (menu items) in a menu list to the user via the loudspeaker 440.

Note that the audible operation guidance need not always be provided to the user using the audio controller 500 and loudspeaker 440. The user may make an operation to a target apparatus on the basis of a plurality of pieces of haptic information to be described later or at least one of the plurality of pieces of haptic information.

The user determines an appropriate choice in consideration of the apparatus operation purpose provided via the loudspeaker 440. On the other hand, on the target apparatus side, the haptic information display controller 460 controls the apparatus display & input unit 410 to set the dummy button 420 and display portion 430 on the upper surface of that button in a three-dimensional state to display the apparatus operation purpose.

The user then touches the three-dimensional patterns of the display portion 430 on ach dummy button 420 displayed on the apparatus display & input unit 410 with a finger to recognize the position of the dummy button 420 by the haptic sense and presses the dummy button 420 to be selected.

When the user has pressed the dummy button 420 corresponding to a desired apparatus operation, the user's intention is delivered to the target apparatus as an operation instruction. The central processing unit 450 recognizes the user's intention on the basis of the operation instruction, and simultaneously authenticates the user on the basis of the user's fingerprint detected from the finger that pressed the dummy button 420.

A detailed sequence of confirmation of the user's intention and user authentication by the information input/output apparatus 400 will be described below.

The input information controller 490 makes operation control for analyzing user information (operation instruction information to the apparatus and fingerprint information) on the basis of input information obtained from the haptic information input portions 520 to 540, which are arranged in a matrix, as shown in FIG. 23.

The input information controller 490 detects an operation of user's choice from the positions of the haptic display elements that input contact information, and also recognizes user's fingerprint information from the distribution of the haptic display elements that input the contact information.

Upon detecting an operation of user's choice, the input information controller 490 can determine a position where input signals from the haptic display elements of the haptic information input portions 520 to 540 are concentrated as a position pressed by the user. Also, in order to recognize user's fingerprint information, a fingerprint pattern can be determined by analyzing the distribution state of input signals from the haptic display elements.

The input information controller 490 sends the position information of the dummy button 420 recognized as one touched with the user's finger to the central processing unit 450 and haptic information display controller 460. At this time, the central processing unit 450 uses the aforementioned information to select an operation to be executed by the target apparatus. The haptic information display controller 460 displays the choice (dummy button 420) pressed by the user as haptic information on the target apparatus, and informs the user that his or her operation has been recognized. That is, as the dummy button 420, haptic information (sensed as a convex shape, with a different resistance (feel), or with a stimulus (electrical one or the like)), which is different from a surrounding portion so that the presence of a button can be recognized by touch, is displayed.

More specifically, when the user has pressed the dummy button 420 which is indicated by the convex state, the input information controller 490 changes the dummy button 420 to a concave state. The user can confirm that his or her operation instruction has been recognized by the target apparatus on the basis of a change in haptic information as a change in such three-dimensional state.

The input information controller 490 sends recognized fingerprint information to the fingerprint recognition unit 470. The fingerprint recognition unit 470 specifies the user who made the above operation with reference to data registered in the fingerprint data registration unit 480, and sends that result to the central processing unit 450.

Upon reception of the position (contact position) of the dummy button 420 of user's choice, and the personal authentication result of the user from the fingerprint authentication unit 470, the central processing unit 450 determines an operation of the target apparatus on the basis of the operation of user's choice to the target apparatus, and the user's personal information. That is, if it is determined based on the user authentication result that the user is an already registered authentic user, the central processing unit 450 controls the target apparatus to execute an operation corresponding to the button contents of user's choice.

According to this embodiment, when the user selects an arbitrary menu item from a menu list provided to operate the target apparatus, since user authentication for determining if that user is authentic to the target apparatus is simultaneously done, acquisition of the user's intention and user recognition (specification) can be made together, thus greatly improving the user's operability of the target apparatus.

The operation purpose and sequence of the target apparatus, menu list of choices, and the like are provided to the user as audible information and haptic information, and the haptic information is displayed so that he or she can recognize information contents of a plurality of menu items by touching them with a finger. Hence, the user can operate the target apparatus with reference to the audible information and haptic information, and can recognize an operation button by his or her natural sense without resort to visible information.

(2) Second Embodiment

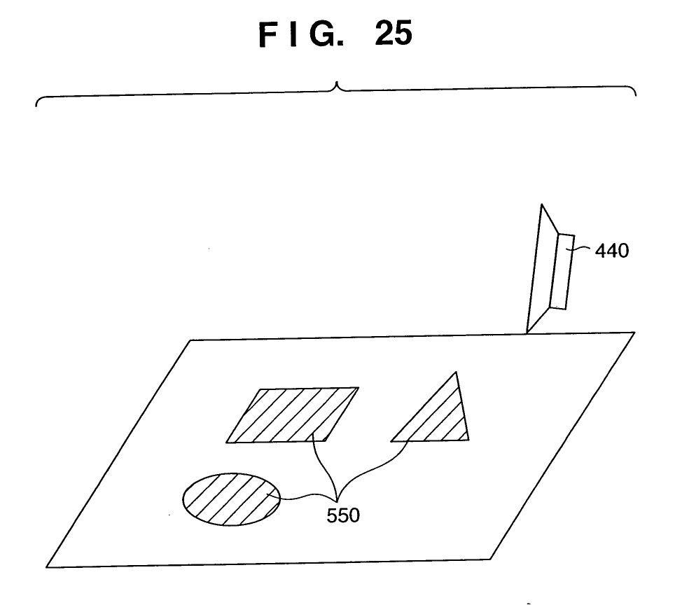

The second embodiment of the information input/output apparatus of the present invention will be described below with reference to FIG. 25.

Referring to FIG. 25, reference numerals 550 denote dummy operation buttons which present haptic information different from that of the dummy buttons 420 shown in FIG. 22. Note that reference numeral 440 denotes a loudspeaker.

Since the functions of the information input/output apparatus of this embodiment are basically the same as those of the information input/output apparatus 400 of the first embodiment shown in FIG. 23, a detailed description thereof will be omitted.

The purpose and sequence of an apparatus operation, choices, and the like are audibly presented to the user, and dummy buttons that can exchange haptic information are also presented to the user in the same manner as in the above first embodiment.

As a difference upon comparison between this embodiment and the first embodiment, the haptic information display controller 460 presents dummy buttons using another haptic information in place of three-dimensional patterns. For example, the haptic information display controller 460 presents haptic information by giving an electrical stimulus or temperature difference to a user's finger via each dummy button 550.

As a result, the user can recognize different regions (positions of the dummy buttons 550) as haptic stimuli based on changes in haptic sense other than a change in physical patterns, i.e., three-dimensional patterns.

The central processing unit 450 stops giving haptic stimuli such as the electrical stimulus, thermal stimulus, and the like to the dummy buttons 550 given with these stimuli after the user has pressed the user, upon providing, to the user, haptic information indicating whether or not the target apparatus has recognized the user's operation.

Therefore, according to this embodiment, the user can appropriately issue an operation instruction to the target apparatus using the dummy button 550 with the aforementioned haptic stimulus.

Since the result indicating whether or not the target apparatus has correctly recognized the user's operation instruction, i.e., user's intention, and the user authentication result determined based on fingerprint information are fed back to the user, information communications between the user and target apparatus can be quickly and easily made. In this manner, the user can make even menu selection using a dummy control panel, thus greatly improving user's operability.

(3) Third Embodiment

The third embodiment of the information input/output apparatus of the present invention will be described below.

In this embodiment, when the user selects a desired menu item from a menu list to make the target apparatus execute a desired operation, visible information is presented to the user together with the haptic information described in the first or second embodiment.

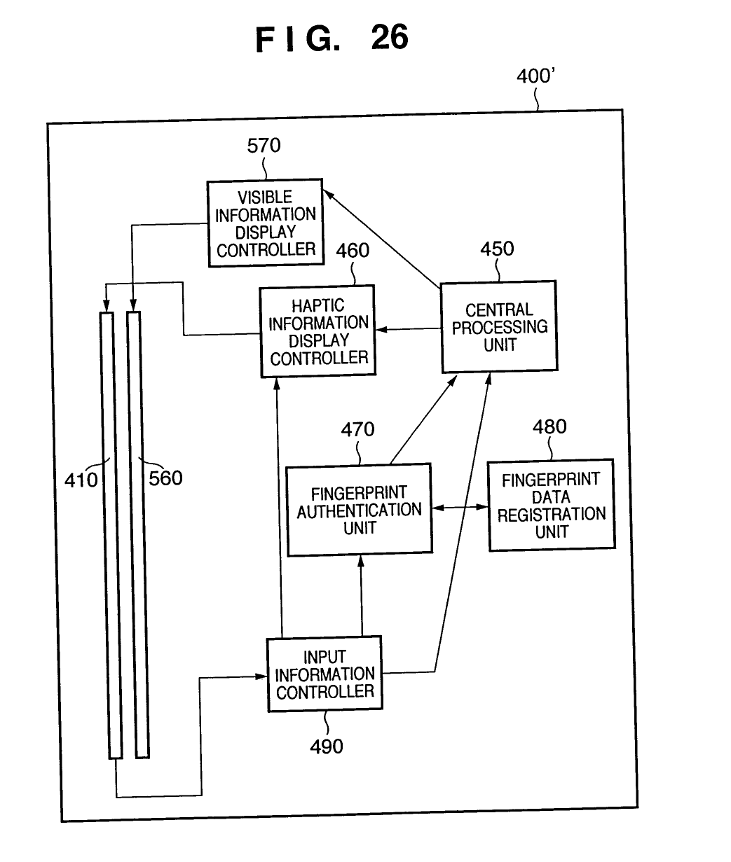

FIG. 26 shows the functional arrangement of an information input/output apparatus 400′ according to this embodiment. Referring to FIG. 26, reference numeral 450 denotes a central processing unit; 460, a haptic information display controller; 470, a fingerprint authentication unit; 480, a fingerprint data registration unit; 490, an input information controller; 410, haptic information display elements; 560, visible information display elements; and 570, a visible information display controller.

The arrangement of the information input/output apparatus 400′ of this embodiment is basically the same as that of the first embodiment. In this embodiment, the visible information display elements 560 used to provide visible information to the user are arranged behind the haptic information display elements 410. In this embodiment, the visible information display controller 570 is added.

If the haptic information display elements 410 are made up of a transparent material, the user can recognize information (user's intention and user recognition result) based on t xt information and image information displayed on the visible information display elements 560 arranged behind the haptic information display elements 410.

In this embodiment, appropriate information is provided to the user using haptic information and visible information together. Therefore, this embodiment is not limited to the above arrangement in which the visible information display elements 560 are arranged behind the haptic information display elements 410.

For example, the haptic information display elements 410 may be arranged behind the visible information display elements 560, so that the user may acquire visible information from the visible information display elements 560, and acquire haptic information (a stimulus based on a change in, e.g., three-dimensional pattern, electrical stimulus, thermal stimulus, and the like) from the haptic information display elements 410.

In this embodiment, an operation purpose or the like is displayed on an operation apparatus as text information to explain it. The arrangement shown in FIG. 26 does not include the audio processor 500 and loudspeaker 440 described in FIGS. 22 and 23. However, by adding these components, an audible comment may be provided to the user.

In this case, in order to present an audible operation guidance to the user, the arrangement including the audio processor 500 and loudspeaker 440 having the same functions as those in the first embodiment is adopted. The operations of the audio processor, loudspeaker 440, central processing unit 450, and the like at that time are the same as those described in the first embodiment.

According to this embodiment, an operation menu list to be presented upon using the target apparatus is provided to the user as visible information together with haptic information and audible information. For this reason, since the positions and contents of dummy buttons as choices to be directly operated by the user are also displayed as text information and image information, the user can easily recognize the configuration of the apparatus display & input unit (haptic information display elements) 410 as a control panel.

The result indicating whether or not the target apparatus side has correctly recognized the user's operation instruction (depression of a dummy button) to the target apparatus and the user recognition result based on the fingerprint information can be reliably and effectively presented to the user, since haptic information and visible information are used together.

By ffectively using haptic information, a natural operation feeling can be given to the user.

The information input/output apparatus of the present invention can also be implemented by supplying a recording medium, which records a program code of software that can implement the functions of a host and terminal of the first to third embodiments to a system or apparatus, and reading out and executing the program code stored in the recording medium by a computer (or a CPU or MPU) of the system or apparatus.

In this case, the program code itself read out from the recording medium implements the functions of the above-mentioned embodiments, and the recording medium which records the program code and that program code constitute the present invention.

As the recording medium for supplying the program code, for example, a ROM, flexible disk, hard disk, optical disk, magneto-optical disk, CD-ROM, CD-R, magnetic tape, nonvolatile memory card, and the like may be used.

The functions of the first to third embodiments may be implemented not only by executing the readout program code by the computer but also by some or all of actual processing operations executed by an OS running on the computer on the basis of an instruction of the program code.

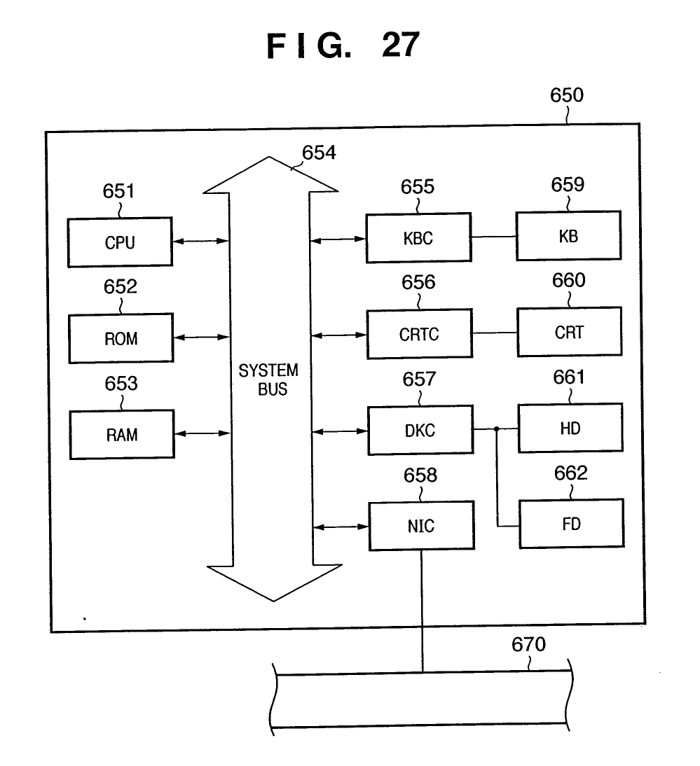

FIG. 27 shows a computer system 650.

As shown in FIG. 27, the computer system 650 comprises a CPU 651, a ROM 652, a RAM 653, a keyboard controller (KBC) 655 for a keyboard (KB) 659, a CRT controller (CRTC) 656 for a CRT display (CRT) 660 as a display unit, a hard disk controller (DKC) 657 for a hard disk (HD) 661 and flexible disk (FD) 662, and a network interface controller (NIC) 658 for establishing connection to a network 670, which are connected via a system bus 654 to be able to communicate with each other.

The CPU 651 systematically controls the respective components connected to the system bus 654 by executing software recorded on the ROM 652 or HD 661 or software supplied from the FD 662.

That is, the CPU 651 implements the operations of this embodiment by reading out and executing a processing program according to a predetermined processing sequence from the ROM 652, HD 661, or FD 662.

The RAM 653 serves as a main memory, work area, or the like of the CPU 651.

The KBC 655 controls instruction inputs from the KB 659, a pointing device (not shown), and the like.

The CRTC 656 controls display on the CRT 660.

The DKC 657 controls access to the HD 661 and FD 662 that record a boot program, various applications, edit files, user files, a network management program, the predetermined processing program of this embodiment, and the like.

The NIC 658 exchanges data with an apparatus or system on the network 670 in two ways.

As can be understood from the above description, the information input/output apparatus of the present invention comprises the aforementioned complex functional device, can reliably execute user authentication on the basis of information obtained upon user's touching the device with a finger, and can improve operability.

More specifically, since the electronic apparatus can reliably execute user authentication, the user is specified every time that user operates the electronic apparatus.

In this case, it is also characterized in that a menu list with a variety of haptic information is presented to the user, and user authentication is executed when the user touches an arbitrary menu item of the presented menu list.

Furthermore, in order to provide the information input/output apparatus of the present invention which allows the user to make information input/output operations with good operability, when the user selects a menu item from the menu list on the electronic apparatus by touching it with a finger, he or she is given a haptic stimulus, and can recognize the positions of selectable menu items.

With the information input/output apparatus of the present invention, the user can recognize whether or not the electronic apparatus has correctly recognized the contents of a user's operation instruction.

Furthermore, with the information input/output apparatus of the present invention, the user can experience virtual operations using dummy buttons as if he or she were actually operating the electronic apparatus.

As described above, according to the information input/output apparatus of the present invention, a list of a plurality of menu items used to operate the target apparatus is presented, and user's fingerprint information is acquired to authenticate the user when the user touches an arbitrary menu item with a finger. Hence, every time the user operates the target apparatus, that user can be specified and securely authenticated. Since the user authentication uses fingerprint information, the user can be prevented from being erroneously recognized as another user, and the need for inputting a password and the like can be obviated. Hence, the user's operability upon operating the target apparatus can be greatly improved without troubling the user.

The present invention is not limited to the above embodiments and various changes and modifications can be made within the spirit and scope of the present invention. Therefore, to apprise the public of the scope of the present invention, the following claims are made.

What is claimed is:

1. A complex functional apparatus comprising a haptic information element having haptic information portions corresponding to a plurality of different kinds of haptic information,
each haptic information unit including:
a first function unit configured to detect corresponding haptic information; and
a second function unit configured to reproduce some or all pieces of detected haptic information.

2. The apparatus according to claim 1, wherein each haptic information unit has a plurality of electrode pairs,
the first function unit obtains detection signals of the haptic information via the electrode pairs, and
the second function unit reproduces some or all pieces of haptic information by converting the haptic information into physical quantities which are the same as or different from the detection signals by inputting electric power from an external power supply to the electrode pairs.

3. The apparatus according to claim 2, wherein the electrode pairs are formed via a metal oxide film, and
the metal oxide film detects the detection signals.

4. The apparatus according to claim 3, wherein the metal oxide film is formed of a ferroelectric or pyroelectric.

5. The apparatus according to claim 1, wherein the plurality of different kinds of haptic information include a temperature and pressure.

6. The apparatus according to claim 5, wherein at least the haptic information unit which corresponds to a pressure as the haptic information is formed on a cantilever-shaped elastic member.

7. The apparatus according to claim 5, wherein the haptic information unit which corresponds to a pressure as the haptic information detects a frequency and amplitude of a pressure acting on that portion, and is mechanically displaced at a frequency and amplitude according to the detection signal or pre-set pressure information by the external power supply.

8. The apparatus according to claim 5, wherein said haptic information element comprises a plurality of stacked structures each of which has an electrode, metal oxide film, and electrode structure formed on a cantilever-shaped elastic member.

9. The apparatus according to claim 5, wherein said haptic information element comprises a plurality of stacked structures each of which has an electrode, metal oxide film, and electrode structure formed on a cantilever-shaped elastic member, and another stacked structure arranged around the elastic member.

10. The apparatus according to claim 8, wherein the haptic information is detected based on an output from each stacked structure, and some or all detection signals are converted into physical quantities which are the same as or different from the detection signals by inputting electric power from the external power supply to that stacked structure so as to reproduce the haptic information.

11. The apparatus according to claim 8, wherein a plurality of cantilever-shaped elastic members are arranged in a rotation symmetry relationship.

12. The apparatus according to claim 1, wherein a plurality of haptic information elements equivalent to said haptic information element are linearly or two-dimensionally arranged.

13. A haptic information system comprising:
a complex functional apparatus;
an input controller configured to receive signals from respective haptic information elements;
an arithmetic processor configured to store the signals and applying a signal process to the stored signals; and
an output controller configured to read out the signals from said arithmetic processor and output the readout signals to said complex functional device,
wherein said complex functional apparatus comprises haptic information elements each having haptic information units corresponding to a plurality of different kinds of haptic information, and each haptic information unit includes a first function unit configured to detect corresponding haptic information, and a second function unit configured to reproduce some or all pieces of detected haptic information.

14. The system according to claim 13, further comprising a communication circuit for exchanging the signals with an external apparatus.

15. A complex functional apparatus comprising a substrate, a metal oxide layer formed on said substrate, and an electrode, wherein said apparatus detects a plurality of different kinds of information by electrodes formed on a plurality of portions obtained by dividing said metal oxide layer.

16. The apparatus according to claim 15, wherein said metal oxide layer divided into the plurality of portions forms one element, and elements equivalent to that element are arranged linearly or two-dimensionally.

17. The apparatus according to claim 15, wherein said metal oxide layer comprises a ferroelectric or pyroelectric, and the information to be detected is one of a pressure, temperature, acceleration, and angular acceleration.

18. The apparatus according to claim 17, wherein said ferroelectric or pyroelectric is formed by alternately stacking crystal planes formed of a metal—oxygen, and crystal planes formed of oxygen alone, or alternately stacking crystal planes formed of a plurality of metals and oxygen.

19. The apparatus according to claim 15, wherein at least one portion of said metal oxide layer divided into the plurality of portions is formed on an elastic member attached to a hollow space structure.

20. The apparatus according to claim 19, wherein the portion that detects a temperature has the hollow space structure.

21. A complex functional apparatus comprising a detection device which comprises a substrate, a metal oxide layer formed on said substrate, and an electrode, detects a plurality of different kinds of information by electrodes arranged on a plurality of portions obtained by dividing said metal oxide film, and is stacked on a display configured to display video information.

22. The apparatus according to claim 21, wherein at least one portion of said metal oxide layer is formed on an elastic member attached to a hollow space structure.

23. The apparatus according to claim 22, wherein at least the portion that detects a pressure is attached to the elastic member attached to the hollow space structure.

24. The apparatus according to claim 21, wherein the electrodes of the portions that respectively detect a temperature and pressure are transparent electrodes.

25. A method of manufacturing a complex functional apparatus which detects a plurality of different kinds of information by electrodes formed on a plurality of portions obtained by dividing a metal oxide film, comprising: forming the metal oxide layer by independently supplying a metal source material and oxygen source material which form the metal oxide layer to a substrate.

26. The method according to claim 25, wherein a metal and oxygen which form the metal oxide layer are supplied from independent supply devices to alternately stack crystal planes formed of the metal and oxygen and crystal planes formed of the oxygen.

27. The method according to claim 26, wherein a metal component source material supplied from the independent supply device is a material selected from the group consisting of a metal, metal oxide, organometallic compound, and metal halide, and an oxygen source gas is a material selected from the group consisting of oxygen, ozone, and nitrogen oxide.

28. The method according to claim 27, wherein at least one of a heating device, an ionization device, a plasma conversion device, and an acceleration electrode for accelerating a charge substance is attached to the metal source gas supply device, and the source gas is supplied while being d composed and/or accelerated by the device attached.

29. The method according to claim 27, wherein at least one of a heating device, an ionization device, and a plasma generator is attached to the metal source gas supply device, and the source gas is supplied while being activated by the device attached.

30. An information input/output apparatus for controlling an operation of a target apparatus on the basis of a user authentication result associated with a user who operates the target apparatus, comprising:
a menu presentation unit configured to present a list of a plurality of menu items used to operate the target apparatus;
a haptic information acquisition unit acquire haptic information of the user on the basis of a position of the menu item that the user touches with a finger of the plurality of menu items presented by said menu presentation unit; and
a user authentication unit authenticate the user on the basis of the haptic information acquired by said haptic information acquisition unit.

31. The apparatus according to claim 30, further comprising a haptic information output unit configured to output haptic information in a state that allows the user to recognize information contents thereof upon user's touching the information with the finger at the position of each menu item presented by said menu presentation unit.

32. An information input/output apparatus for outputting predetermined haptic information to a user, and inputting a user's reaction made for the output haptic information, comprising:
a haptic information output unit configured to output a plurality of menu items required for the user to operate a target apparatus as haptic information in a state that allows the user to recognize information contents thereof upon user's touching the information with a finger;
a haptic information input unit configured to acquire a user's fingerprint on the basis of a position of the menu item touched by the user of the plurality of menu items output by said haptic information output unit; and
user information processor configured to acquire a user's intention and authenticate the user on the basis of the user's fingerprint acquired by said haptic information input unit.

33. The apparatus according to claim 32, further comprising recognition result output unit configured to inform the user of at least one of information indicating whether or not the target apparatus has recognized the user's intention acquired by said user information processor, and authentication result information of the user by said us r information processor in a state that allows the user to recognize contents of the information upon user's touching the information with the finger.

34. The apparatus according to claim 31, wherein the haptic information output by said haptic information output unit is information perceived by the user as at least one physical quantity of a three-dimensional pattern, electricity, and calorific value at respective positions of the plurality of menu items.

35. The apparatus according to claim 30, wherein the user is authenticated on the basis of fingerprint information of the user, which is detected from a distribution of at least one physical quantity of a pressure and calorific value produced by the finger of the user.

36. The apparatus according to claim 31, further comprising image display configured to visually display predetermined image information, and wherein both the image information displayed on said image display , and the haptic information output by said haptic information output unit are presented to the user.

37. An information input/output method for controlling an operation of a target apparatus on the basis of a user authentication result associated with a user who operat s the targ t apparatus, comprising:
a menu presentation step of presenting a list of a plurality of menu items used to operate the target apparatus;
a fingerprint information acquisition step of acquiring fingerprint information of the user on the basis of a position of the menu item that the user touches with a finger of the plurality of menu items presented in the menu presentation step; and
a user authentication step of authenticating the user on the basis of the fingerprint information acquired in the fingerprint information acquisition step.

38. An information input/output method in an information input/output apparatus for outputting predetermined haptic information to a user, and inputting a user's reaction made for the output haptic information, comprising:
a haptic information output step of outputting a plurality of menu items required for the user to operate a target apparatus as haptic information in a state that allows the user to recognize information contents thereof upon user's touching the information with a finger;
a haptic information input step of acquiring a user's fingerprint on the basis of a position of the menu item touched by the user of the plurality of menu items output in the haptic information output step; and
a user information processing step of acquiring a user's intention and authenticating the user on the basis of the user's fingerprint acquired in the haptic information input step.

39. A computer program for implementing an information input/output method for controlling an operation of a target apparatus on the basis of a user authentication result associated with a user who operates the target apparatus, comprising:
a menu presentation step of presenting a list of a plurality of menu items used to operate the target apparatus;
a fingerprint information acquisition step of acquiring fingerprint information of the user on the basis of a position of the menu item that the user touches with a finger of the plurality of menu items presented in the menu presentation step; and
a user authentication step of authenticating the user on the basis of the fingerprint information acquired in the fingerprint information acquisition step.

40. A computer program for implementing an information input/output method in an information input/output apparatus for outputting predetermined haptic information to a user, and inputting a user's reaction made for the output haptic information, comprising:
a haptic information output step of outputting a plurality of menu items required for the user to operate a target apparatus as haptic information in a state that allows the user to recognize information contents thereof upon user's touching the information with a finger;
a haptic information input step of acquiring a user's fingerprint on the basis of a position of the menu item touched by the user of the plurality of menu items output in the haptic information output step; and
a user information processing step of acquiring a user's intention and authenticating the user on the basis of the user's fingerprint acquired in the haptic information input step.

41. A computer readable recording medium recording a program of claim 39.

42. An information input/output apparatus for controlling an operation of a target apparatus on the basis of a user authentication result associated with a user who operates the target apparatus, comprising:
a menu presentation unit configured to present a list of a plurality of menu items used to operate the target apparatus;
a haptic information acquisition unit configured to acquire haptic information of the user on the basis of a position of the menu item that the user touches with a finger of the plurality of menu items presented by said menu presentation means; and
a user authentication unit configured to authenticate the user on the basis of the haptic information acquired by said haptic information acquisition unit,
wherein said haptic information acquisition unit comprises a haptic information element having haptic information units corresponding to a plurality of different kinds of haptic information, and each haptic information unit includes a first function unit configured to detect corresponding haptic information, and a second function unit reproduce some or all pieces of detected haptic information.

43. An information input/output apparatus for controlling an operation of a target apparatus on the basis of a user authentication result associated with a user who operates the target apparatus, comprising:
a menu presentation unit configured to present a list of a plurality of menu items used to operate the target apparatus;
a haptic information acquisition unit configured to acquire haptic information of the user on the basis of a position of the menu item that the user touches with a finger of the plurality of menu items presented by said menu presentation unit; and
a user authentication unit configured to authenticate the user on the basis of the haptic information acquired by said haptic information acquisition unit,
wherein said haptic information acquisition unit comprises a substrate, a metal oxide layer formed on the substrate, and an electrode, and detects a plurality of different kinds of information by electrodes formed on a plurality of portions obtained by dividing the metal oxide layer.
